(19) United States
(12) Patent Application Publication
(10) Pub. No.: US 2001/0035342 A1
(43) Pub. Date: Nov. 1, 2001

(54) System for delivering electromagnetic energy into a solution

(76) Inventors: Dwain E. Morse, Santa Barbara, CA (US); James H. Cook, Santa Barbara, CA (US); Thomas G. Matherly, Lompoc, CA (US)

Correspondence Address: Scott W. Kelley, KELLY BAUERSFELD LOWRY & KELLEY, LLP, Suite 1650, 6320 Canoga Avenue, Woodland Hills, CA, 91367, US

(21) Appl. No.: 09/797,393

(22) Filed: Mar. 1, 2001

Related U.S. Application Data
(63) Continuation-in-part of application No. 08/695,039, filed on Aug. 9, 1996, now abandoned.
Application No. 08/695,039 is a continuation of application No. PCT/US96/01122, filed on Jan. 22, 1996.

(51) Int. Cl. H05F 3/00; B01D 57/00; B03C 1/00; B03C 9/00; C01B 31/00; C01B 5/00; C02F 1/00; C02F 1/30

(52) U.S. Cl. 204/164; 204/555; 204/556; 210/748; 204/173

(57) ABSTRACT

A system for delivering electromagnetic energy into a solution using a delivery apparatus to modify its characteristics. Preferred systems are described that deliver electromagnetic energy into a target solution for modifying its characteristics by first treating a primary solution, e.g., water or any hydrogen bonded liquid, and then causing the primary solution to be proximate to the target solution. The treated secondary solution improves the performance of various processes including: scale control in water heater systems, printing ink treatment, de-inking of pulp paper, etc.

### RELATED APPLICATION

This application is a continuation-in-part of U.S. application Ser. No. 08/695,039, filed Aug. 9, 1996, which is a continuation of International Application No. PCT/US96/01122, filed Jan. 22, 1996, which is based on U.S. patent application Ser. No. 08/554,458, filed Nov. 7, 1995, and U.S. patent application Ser. No. 08/378,462, filed Jan. 25, 1995 (now U.S. Pat. No. 5,606,723).

### BACKGROUND OF THE INVENTION

The present invention relates to systems for delivering electromagnetic energy into a colloidal suspension, i.e., a solution, for the purpose of modifying its characteristics.

Various systems are known for treating water or other solutions by introducing electric or magnetic energy. For example only, see U.S. Pat. Nos. 4,865,747; 4,865,748; 4,963,268; 5,036,170; 5,074,998; 5,113,751; 5,139,675; 5,171,431; 5,173,169; 5,183,512; 5,183,565; 5,217,607; 5,230,807; 5,236,670; 5,304,289; 5,306,887; 5,320,726; and 5,326,446.

Further, it has been reported in a paper by Zeta-Meter, Inc., a manufacturer of equipment for monitoring zeta potential, that “Zeta potential can help you understand and control colloidal suspensions. Examples include complex biological systems such as blood and functional ones like paint. Colloidal suspensions can be as thick as paste (like cement) or as dilute as the turbidity particles in a lake. Water, milk, wine, clay, dyes, inks, paper and pharmaceuticals are good examples of useful colloidal systems. Water is a common suspending liquid, although non-aqueous liquids are used as well. In many cases, the performance of a suspension can be improved by understanding the effect of colloidal behavior on such properties as viscosity, settling and effective particle size.” See: “Zeta Potential: A Complete Course in 5 Minutes” which is incorporated herein by reference.

Although systems are known for directly treating water or other solutions directly, there has been, up to this point, no teaching in the prior art of treating a primary solution which when placed in relative proximity to a secondary solution imparts beneficial characteristics to that solution. In certain circumstances, it can be quite advantageous to treat one solution which can be circulated through or placed in proximity to a target solution in order to treat the target solution while not removing the target solution for treatment, or installing mechanisms for directly treating the target solution.

Thus, there is a continuing need for a system and process for indirectly treating solutions. The present invention fulfills this need and provides other related advantages.

### SUMMARY OF THE INVENTION

The present invention is directed to a system for delivering electromagnetic energy, e.g., RF-modulated magnetic and electric fields, into a solution for modifying the characteristics of the solution. Furthermore, the present invention is directed to a system for modifying the characteristics of a target solution by delivering electromagnetic energy, i.e., magnetic and electric fields, into a primary solution, e.g., water or any hydrogen bonded liquid, and then causing the primary solution to be proximate to said target solution.

Preferred embodiments of a system for treating a target solution in accordance with the invention are comprised of: 1) first and second containers suitable for respectively containing a primary solution and a target solution, said containers being configured for placing the solutions contained therein in close physical proximity to one another, 2) an electrode located proximate to said first container, 3) an RF signal generator for applying an electromagnetic signal to said electrode suitable for treating a primary solution in said first container, and 4) means for moving solution from at least one of said containers relative to solution in the other of said containers.

In use, the process for affecting physical characteristics of the target solution by transferring energy from the first aqueous primary solution comprises the steps of first delivering electromagnetic energy into the first aqueous solution such that a portion of the energy is absorbed into this first aqueous solution for release therefrom over time. Secondly, the electromagnetic energy is transferred from the first aqueous solution to the target solution by positioning the first aqueous solution relative to the target solution in order to alter a non-thermal physical characteristic of the target solution. Such non-thermal physical characteristic can comprise zeta potential, pH, surface tension, turbidity, conductivity, hydration force, and viscosity.

The altered non-thermal physical characteristic of the target solution is typically monitored and it is determined with the non-thermal physical characteristic of the target solution has reached a predetermined parameter.

The electromagnetic energy delivered to the primary aqueous solution can comprise magnetic energy, light energy, radio frequency energy or electric current energy. In order to reach the predetermined parameter, the transfer of energy from the primary aqueous solution can be altered by increasing the exposure of the target solution to the primary aqueous solution, at least partially shielding the solutions from one another or altering the relative approximate distance between the first aqueous solution and the target solution.

The novel features of the invention are set forth with particularity in the appended claims. Other features and advantages of the present invention will become apparent from the following more detailed description, taken in conjunction with the accompanying drawings which illustrate, by way of example, the principles of the invention.

### BRIEF DESCRIPTION OF THE DRAWINGS

FIG. 1 comprises a block diagram of a preferred embodiment of a delivery system for delivering RF-modulated electromagnetic energy to a solution;

FIG. 2 is a graphical representation of how the zeta potential of a solution is modified as a function of the amplitude and duration of treatment with RF energy;

FIG. 3 is a block diagram of a test bed for determining treatment parameter settings;

FIG. 4 comprises a top level view of a tank showing a distribution of delivery apparatus and associated RF energy distribution;

FIG. 5 comprises a side elevation view of the tank of FIG. 4 along the plane 5-5;

FIG. 6 is a block diagram of the signal generator of the preferred embodiment of FIG. 1;

FIG. 7 is a side elevation view of a preferred distribution of distribution apparatus in a tank along with sensors for monitoring the effectiveness of the treatment parameters;

FIG. 8A is a transparent view of first preferred embodiment of a delivery apparatus;

FIG. 8B is a schematic cross section of the embodiment of FIG. 8A;

FIG. 9A is a transparent view of a second preferred embodiment of a delivery apparatus;

FIG. 9B is a schematic cross section of the embodiment of FIG. 9A;

FIG. 10 is a transparent view of a third preferred embodiment of a delivery apparatus; FIG. 11 is a cross sectional view of the embodiment of FIG. 10 along the plane 11-11;

FIG. 12 is a partial cross sectional view of a fourth preferred embodiment of a delivery apparatus;

FIG. 13 is a partial cross sectional view of a fifth preferred embodiment of a delivery apparatus;

FIG. 14 comprises a block diagram of a preferred embodiment of a remote delivery system for delivering RF-modulated energy to a secondary solution by recirculating a treated primary solution between the delivery apparatus and a process station containing the secondary solution;

FIGS. 15A-15C are block diagrams of alternative radiators for treating the secondary solution with radiation from the primary solution;

FIG. 16 is a block diagram of the delivery system of FIG. 14 showing feedback control of the delivery apparatus;

FIG. 17 is a block diagram of a second preferred embodiment of a remote delivery system where the treatment station contains a tank of primary solution that is recirculated between the process station and the treatment station;

FIG. 18 is a block diagram of a third preferred embodiment of a remote delivery system where the secondary solution is recirculated from the process station to the treatment station where it is passed proximate to a primary solution contained within the delivery apparatus;

FIG. 19 is a block diagram of a fourth preferred embodiment of a remote delivery system where the secondary solution is recirculated from the process station to a tank in the treatment station having a delivery apparatus and a treated primary solution located within;

FIG. 20 is a block diagram of a fifth preferred embodiment of a remote delivery system where the primary solution passes unidirectionally past a delivery apparatus in the treatment station to a process station containing a secondary solution;

FIG. 21 is an exemplary system for treating a secondary solution by recirculating a treated primary solution proximate to the secondary solution;

FIG. 22 is a cross sectional end view of the delivery apparatus of FIG. 21 along the plane 22-22;

FIGS. 23A-23F are schematic diagrams demonstrating additional design criteria that can be used in constructing delivery apparatus for treating a primary solution that is then used to treat a secondary solution;

FIG. 24 is a chart illustrating the comparison of pH over time due to secondary emission in accordance with the present invention;

FIG. 25 is a chart illustrating the atomic force microscopy attractive and repulsive forces as measured in an experiment conducted using the present invention;

FIG. 26 is for photovideographs illustrating crystal formation during an experiment conducted in accordance with the present invention;

FIG. 27 is a graph illustrating the results of turbidity measurements in an experiment conducted using the present invention;

FIG. 28 is another graph illustrating the zeta potential over time in an experiment conducted using the present invention;

FIG. 30 is a schematic view of a primary solution being magnetically treated for purposes of an experiment conducted;

FIG. 31 is a schematic view of a primary solution being treated with microwave energy for use in an experiment conducted using the present invention; and

FIG. 32 is a schematic diagram of a primary solution being treated with electric current for use an experiment conducted using the present invention.

### DETAILED DESCRIPTION OF THE PREFERRED EMBODIMENTS

The present invention relates to systems for delivering electromagnetic energy in the form of magnetic and electric fields into a colloidal suspension, i.e., a solution, for modifying its characteristics. As described in the aforementioned paper by Zeta Meter, Inc., the characteristics of a solution can be desirably altered when its zeta potential is modified. It is believed that the ability to modify a solution's characteristics, e.g., its zeta potential or any other appropriate measure, is improved when it is subjected to an RF-modulated magnetic field and an RF-modulated electric field. Thus, it is an object of the present invention to provide an improved system for delivering RF-modulated electromagnetic energy into a solution.

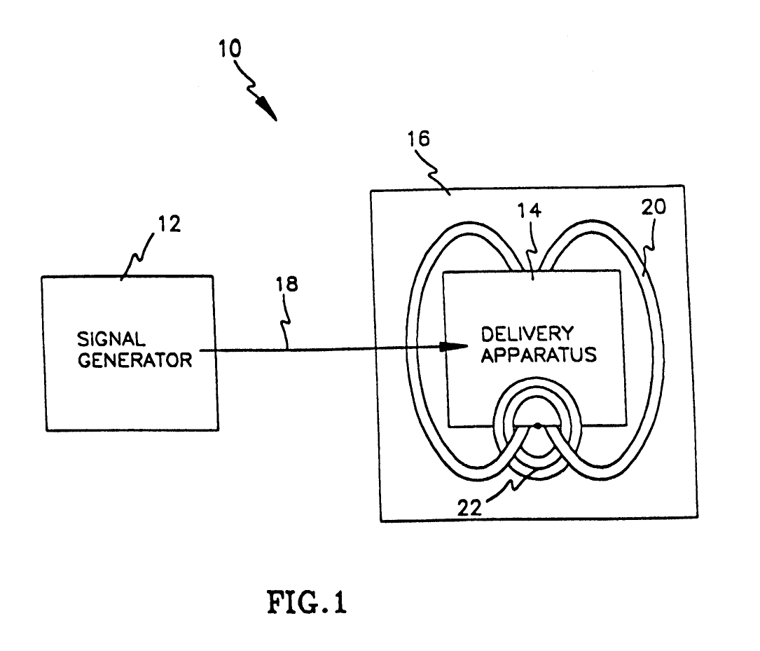

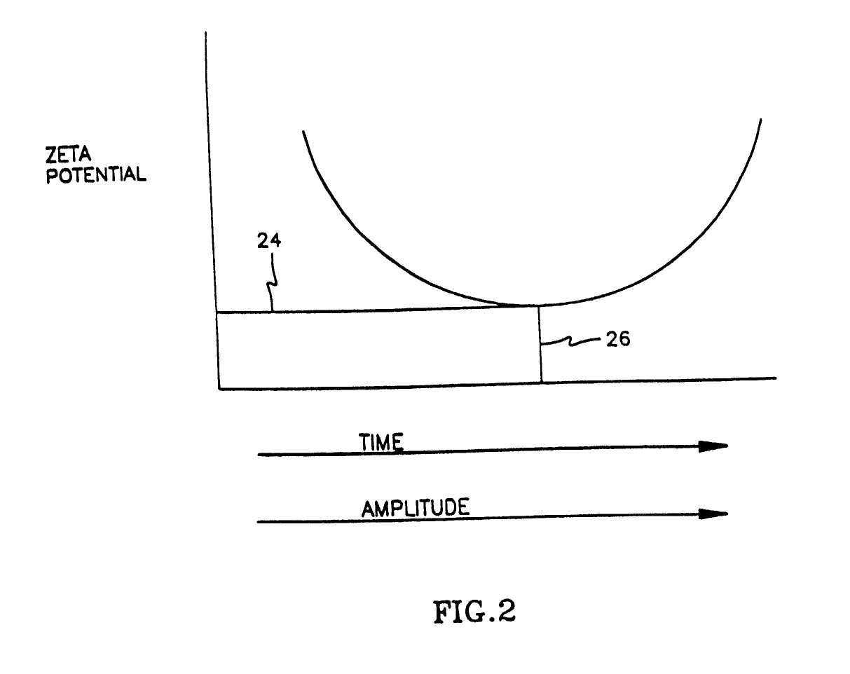

FIG. 1 shows a block diagram of a delivery system 10, primarily comprised of a signal generator 12 and a delivery apparatus 14 contained within a solution 16, e.g., a fluid or gas. The signal generator 12 generates an RF-modulated signal 18 that drives the delivery apparatus 14. The delivery apparatus 14, when stimulated by the RF-modulated signal 18, generates a magnetic field 20 and an electric field 22. As shown in FIG. 2, some solution's characteristics, e.g., its zeta potential, alter as a function of the time duration and/or amplitude of the RF-modulated energy delivered into the solution. However, modification of the zeta potential of the solution in response to RF-modulated energy reaches a valley 24 and reverses when an energy level increases beyond an optimal treatment point 26, as a function of the time duration and/or amplitude of the RF-modulated energy delivered. The modification to the solution is believed to be time limited and thus decreases over time. Thus, preferred embodiments of the present invention apply RF energy for a first time period, remove the RF energy for a second time period and then repeat this application and removal pattern, defining a duty cycle. The duty cycle and the amplitude, i.e., the modulation, cooperatively determine the rate that RF energy is delivered into the solution. ZPM-39633 PATENT

As with most electromagnetic energy, the intensity of energy measured from the delivery apparatus 14 varies with distance. Thus, to uniformly treat the solution 16, the distance from the delivery apparatus 14 and attributes of the RF-modulated signal 18 must be used in conjunction to select treatment parameters, e.g., time duration, duty cycle, amplitude, and distance, which determine a rate that RF energy is applied to the majority of the solution and thus achieve the desired modification.

TABLE I

| | D = 0 | | | | |
|---|---|---|---|---|---|
| | V | D = 6 in. | D = 1 Ft. | D = 4 Ft. | D = 6 Ft. |
| Delivery | (estimated) | V | V | V | V |
| Apparatus | Atmosphere | Water | Water | Water | Water |
| DA I | 5000 | 12.0 | 6.0 | 2.0 | 1.0 |
| DA II | 10,000 | 25.0 | 18.0 | 12.0 | 8.0 |

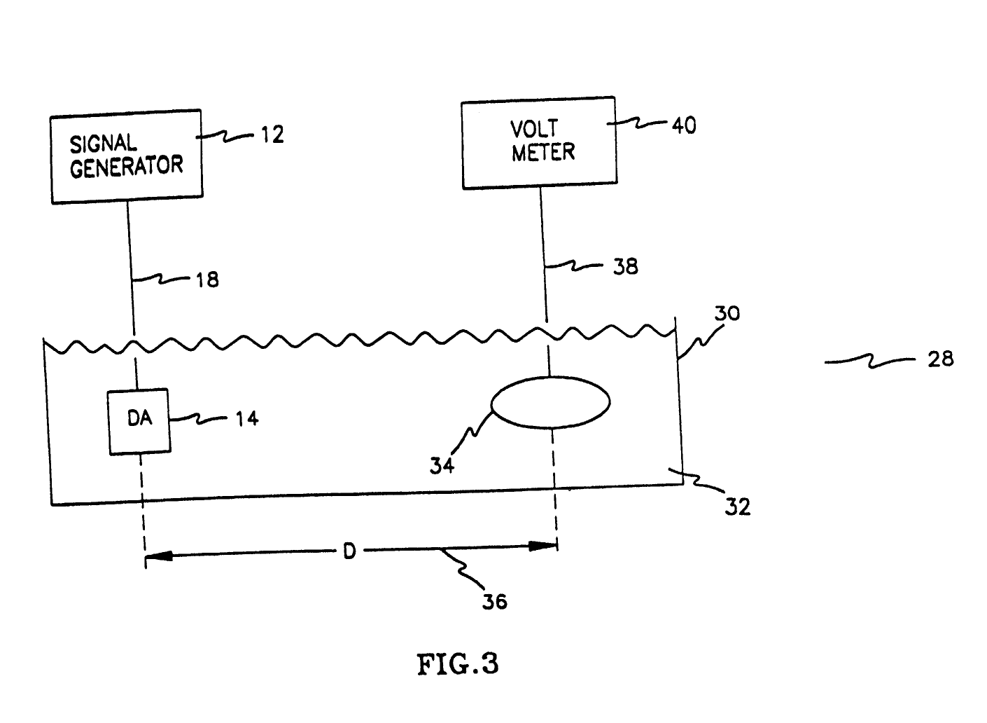

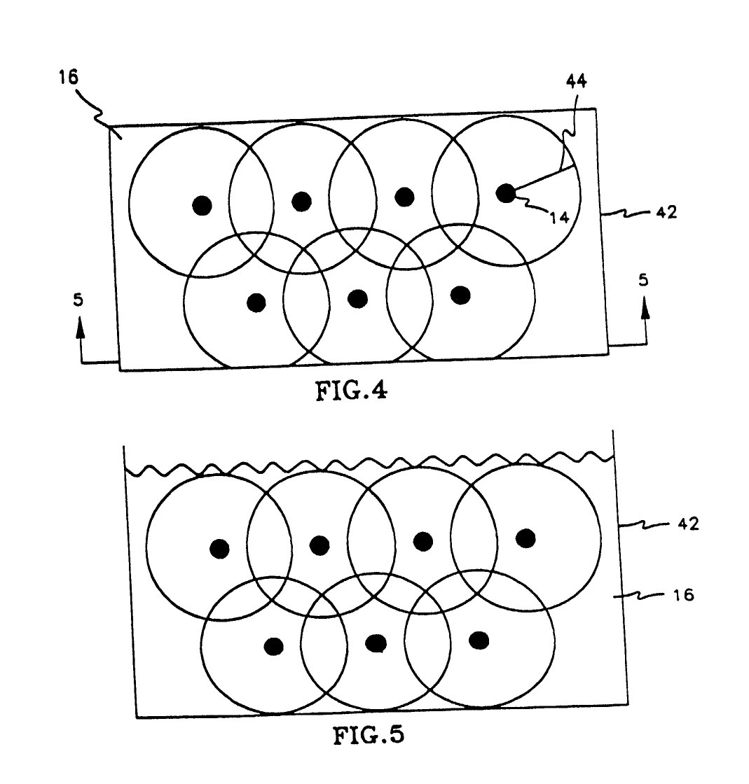

FIG. 3 shows a test bed 28 for determining the treatment parameters. The test bed 28 is comprised of a tank 30 that is filled with a test fluid 32 corresponding to the solution 16 that is to be treated. The delivery apparatus 14 is submerged within the fluid 32 and is driven by the signal generator 12 via the RF-modulated signal 18. A sensor 34, primarily comprised of a coil, is submerged within the fluid 32 a distance 36 away from the delivery apparatus 14. The sensor 34 is coupled via signal path 38 to a voltmeter 40 to measure the magnitude of RF energy coupled from the delivery apparatus 14 to the sensor 34 through the fluid 32. Voltages measured by the voltmeter 40 are believed to correspond to modifications of the fluid 32, e.g., its zeta potential. Using the test bed 28, measurements are taken to determine test data as listed above in Table I corresponding to various preferred embodiments of the delivery apparatus 14 (discussed further below). Accordingly, as shown in FIGS. 4 and 5, a plurality of delivery apparatus 14 are distributed in an actual treatment system tank 42 within a three dimensional matrix. By distributing the delivery apparatus 14 accordingly, radial arcs of treatment distance 44 containing a desired permissible range of RF energy can be positioned to encompass the majority of the solution 16 to be treated. Once the desired treatment distance 44 is chosen, the remaining treatment parameters, the time duration and amplitude of the RF-modulated signal 18, are interactively chosen according to the test data to achieve the desired modification to the solution.

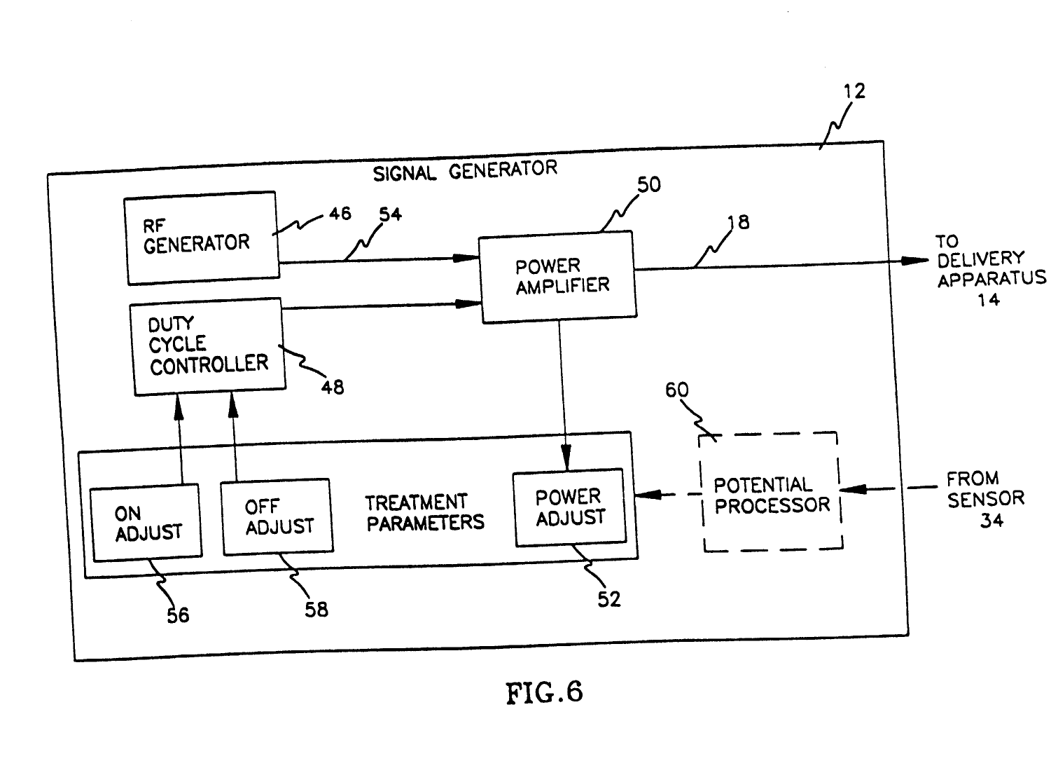

FIG. 6 shows a block diagram of an exemplary signal generator 12, primarily comprised of an RF generator 46 which generates a fixed RF frequency, e.g., 27.225 MHz, a duty cycle controller 48 and a power amplifier 50. The power amplifier 50, under control of a power/amplitude adjustment 52, operates on an RF signal 54 input from the RF generator 46 and outputs a fixed amplitude signal to the delivery apparatus 14 via the RF-modulated signal 18 according to the selected treatment parameters. The duty cycle controller 48 controls the power amplifier 50 by modulating its output on and off. The duty cycle controller 50 is set according to an on adjustment 56 and an off adjustment 58 to generate the duty cycle according to the selected treatment parameters. The on and off adjustments 56, 58 are preferably adjustable in increments, e.g., one minute, up to a duration of sixty minutes. Thus, a typical setting of ten minutes on and sixty minutes off can be accommodated. While FIG. 6 shows an exemplary signal generator 12, any other implementation that provides an RF-modulated signal to a delivery apparatus is considered to be within the scope of a signal generator for the present invention.

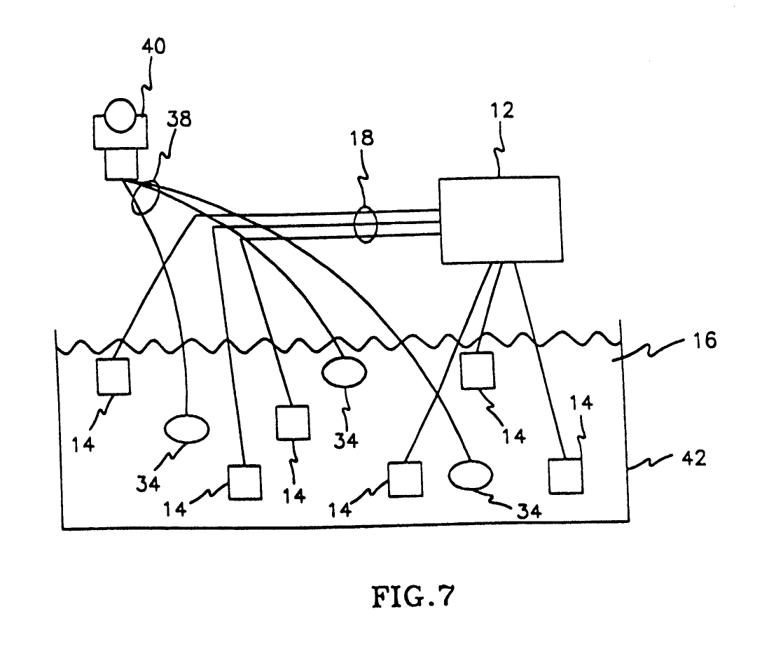

In a preferred embodiment, as shown in FIG. 7, a plurality of sensors 34 are present permitting confirmation of the efficacy of the settings of the treatment parameters in its actual environment. However, it is recognized, that sensors 34 only read voltages that are indicative of the effectiveness of the delivery system 10 which operates in an open loop manner. Thus, in an alternative embodiment, the sensors 34 are replaced by sensors that directly determine the modification to the solution, e.g., its zeta potential value. In this alternative embodiment, a potential processor 60 (see FIG. 6) reads the achieved modification to the solution, e.g., its zeta potential, and accordingly modifies the duty cycle controller 48 and the power amplifier 50 by interactively determining preferred settings for the on adjustment 56, the off adjustment 58 and the power amplitude adjustment 52. Thus, closed loop control is achieved in this alternative embodiment.

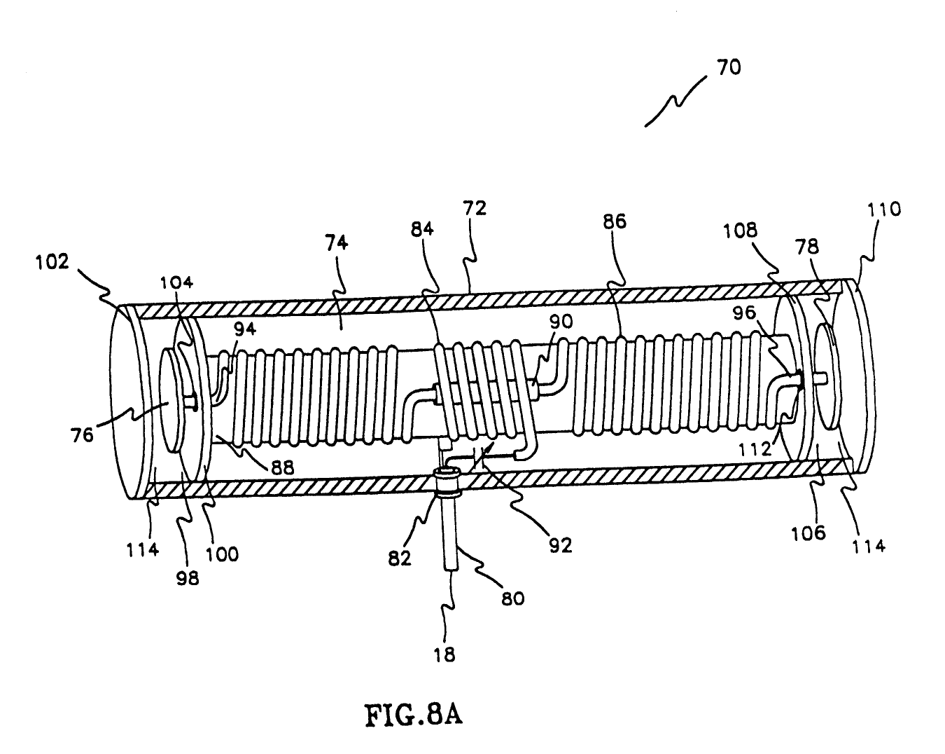

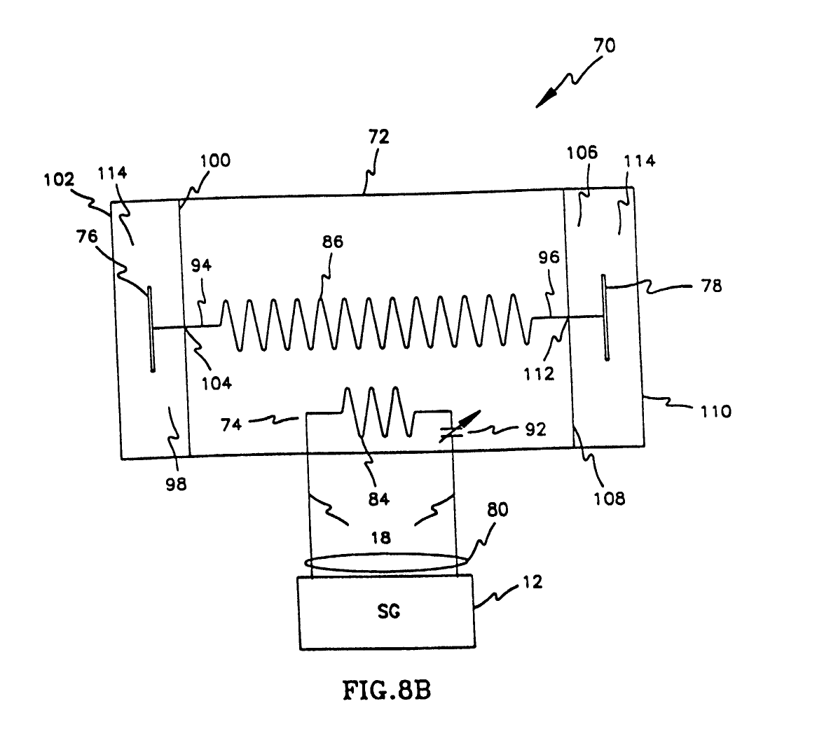

As referenced above in the discussion of Table I, the effectiveness of the delivery system 10 is determined by treatment parameters which are set according to the characteristics for selected delivery apparatus 14 in solution 16. A first preferred delivery apparatus 70, referenced in Table I as DA I, is shown in FIG. 8A. The delivery apparatus 70 is primarily comprised of 1) a water-tight, tubular housing 72, preferably cylindrical, 2) a transformer 74 contained within the housing, 3) first and second voltage probe discs 76 and 78 coupled to the transformer 74 and 4) a coaxial cable 80 coupled to the transformer 74 in the housing 72 through a first water-tight seal 82 and passing the RF-modulated signal 18 from the signal generator 12. As also shown in the schematic representation of FIG. 8B, the transformer 74 is comprised of a primary coil 84 inductively coupled to a secondary coil 86, and having voltage probe discs 76 and 78 coupled to the secondary coil 86, preferably at its ends. The primary and secondary coils 84 and 86 are wound around a tube 88 which is preferably formed of a non-conductive material, e.g., PVC. The primary coil 84 is preferably wound around a portion of the secondary coil 86, and is maintained in electrical isolation from the secondary coil 86 by an insulator 90 or alternatively by forming the coils from insulated conductors. The RF-modulated signal 18 is preferably coupled to the primary coil 84 through a high “Q” variable capacitor 92 which is set to a value to match the impedance of the delivery apparatus 70 to the signal generator 12. When the primary coil 84 is powered by the RF-modulated signal 18, magnetic field 20, also referred to as an H-field, is generated primarily from the secondary coil 86 and extends beyond the delivery apparatus 70 and into the solution 16. The secondary coil 86, as a consequence of inductive coupling to the primary coil 84, generates a voltage (measured between electrical ends 94 and 96) having an amplitude larger than the voltage presented to the primary coil 84 from the RF-modulated signal 18. The voltages from electrical ends 94, 96 are coupled to voltage probe discs 76 and 78, respectively. The voltage probe disc 76 is contained within a first non-conductive water-tight chamber 98 formed at a first end of the housing 72. A first non-conductive inner end plate 100 is sealed at a first inner position of the housing 72 and a first non-conductive thin outer end plate 102, proximate to the first end of the housing 72, is sealed at the first end of the housing 72 to form the chamber 98. The electrical end 94 of the secondary coil 86 is coupled to the voltage probe disc 76 through a second water-tight seal 104. Similarly, a second non-conductive water-tight chamber 106 is formed at the second end of the housing 72 between second inner end plate 108 and second outer end plate 110, having the second voltage probe disc 78 contained within and coupled via a third water-tight seal 112 in second inner end plate 108 to electrical end 96. The chambers 98, 106 are preferably filled with a fluid 114, e.g., deionized water (DI) or any hydrogen bonded liquid. It is believed that coupling the electric field 22, into the fluid-filled chambers 98,106 and through thin outer end plates 102, 110 before coupling the electric field 22 to the solution 16, improves the delivery of the electric field 22 to the solution 16. Also, by maintaining the voltage probe discs 76, 78 in electrical isolation from the solution 16, signal loading is reduced. Sections of the housing 72 which form the first and second water-tight chambers 98,106 are preferably made from non-conductive materials, e.g., PVC. However, the wall section of housing 72 surrounding transformer 74, i.e., between inner end plates 100, 108 can alternatively be fabricated from non-conductive, e.g., PVC, or conductive materials, e.g., copper.

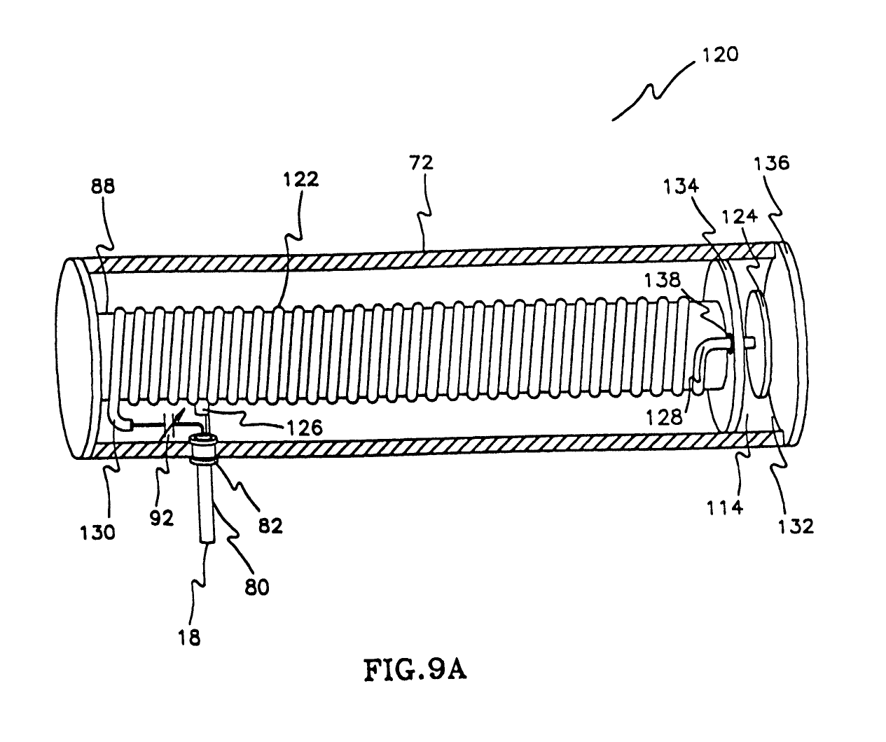

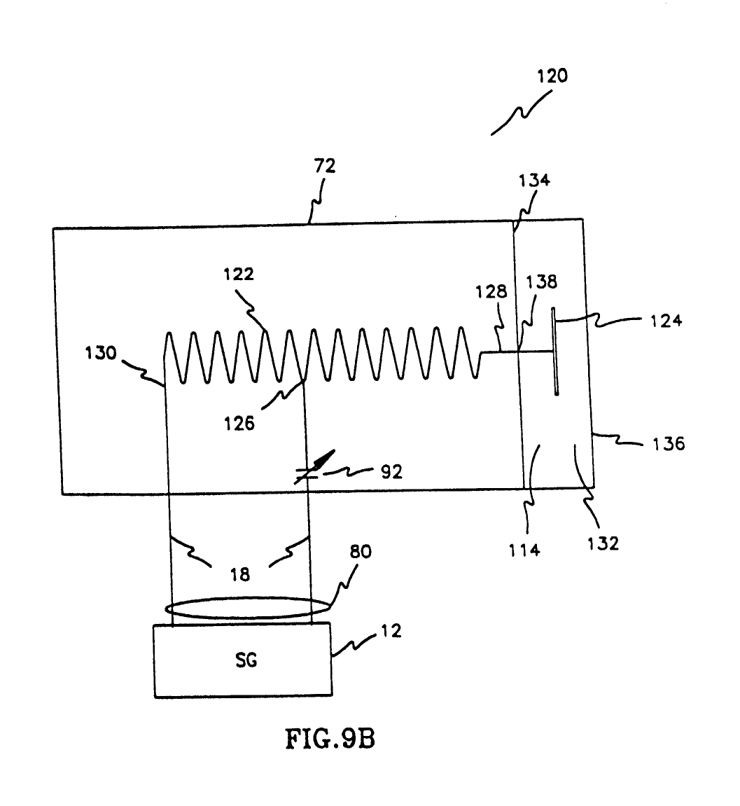

FIGS. 9A and 98 show a second alternative embodiment 120 of the delivery apparatus 14, referred to as DA II in Table I. The delivery apparatus 120 is primarily comprised of 1) water-tight, tubular housing 72, preferably cylindrical, 2) a tapped coil 122 contained within the housing, 3) a voltage probe disc 124 coupled to a first end of the tapped coil 122 and 4) coaxial cable 80 coupled to the tapped coil 122 within the housing 72 through first water-tight seal 82 and passing the RF-modulated signal 18. The coaxial cable 80 is preferably coupled to a second end of the tapped coil 122 and to an intermediate tap point 126 through high “Q” variable capacitor 92, adjusted to match the impedance of the delivery apparatus 120 to the signal generator 12. The tapped coil 122 generates magnetic field 20 that extends into the solution 16 surrounding the delivery apparatus 120. A voltage measured between points 128 and 130 is inductively generated by the tapped coil 122 and is greater in amplitude than the RF-modulated signal 18 input to the tapped coil 122. The voltage at point 128 is coupled to the voltage probe disc 124, contained within a water-tight chamber 132 at the first end of the water-tight housing 72. A non-conductive inner end plate 134 is sealed at a first inner position of the housing 72 and a non-conductive thin outer end plate 136, proximate to the first end of the housing 72, is sealed at the first end of the housing 72 to form the water-tight chamber 132. The voltage generated at the first end of the tapped coil 122 is coupled to the voltage probe disc 124 through a second water-tight seal 138. The chamber 132 is preferably filled with fluid 114, e.g., de-ionized water (DI) or any hydrogen bonded liquid. As with the previously described embodiment, it is believed that this structure improves the coupling of the electric field 22 into the solution 16, while minimizing the electrical load. As previously described, the section of the housing 72 which forms the water-tight chamber 132 is preferably made from a non-conductive material, e.g., PVC. However, the wall section of housing 72 surrounding the tapped coil 122 can alternatively be fabricated from a non-conductive, e.g., PVC, or conductive, e.g., copper, material.

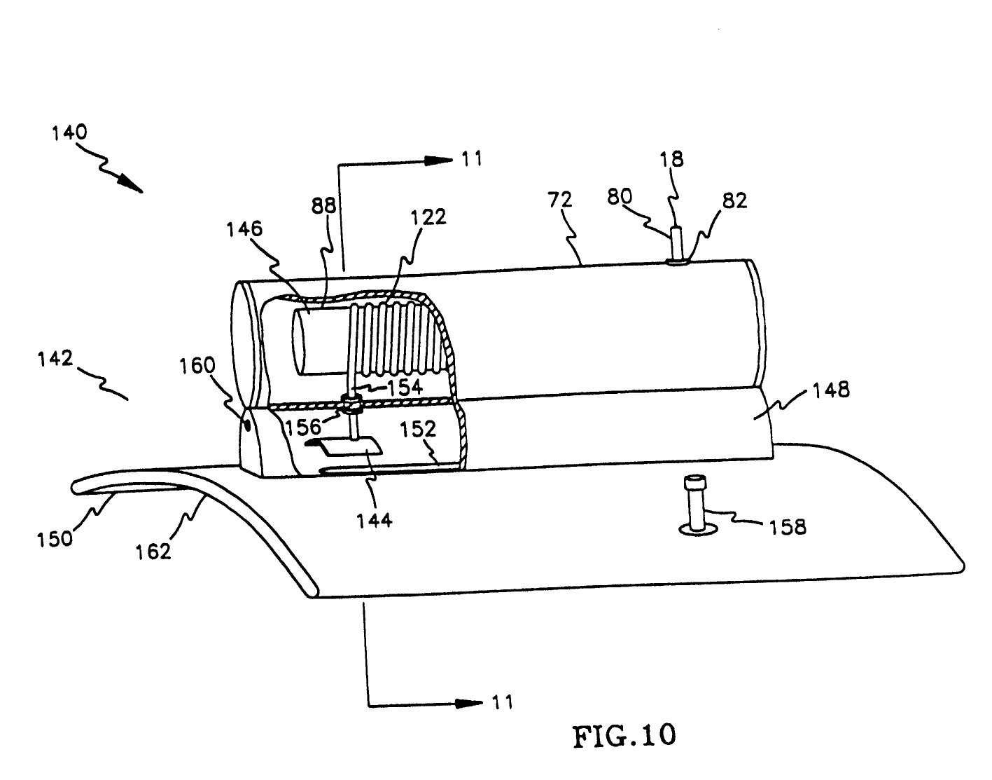

FIGS. 10 and 11 show a third alternative embodiment 140 of delivery apparatus 14. The delivery apparatus 140 is primarily comprised of 1) water-tight, tubular housing 72, preferably cylindrical, 2) tapped coil 122 contained within the housing, 3) a voltage coupling structure 142 containing a voltage coupling plate 144 coupled to a first end 146 of the tapped coil 122, and 4) coaxial cable 80 coupled to the tapped coil 122 in the housing 72 through first water-tight seal 82 and passing the RF-modulated signal 18. Essentially, the structure of the water-tight housing 72 and the tapped coil 122 are identical with the previously-described embodiment 120 shown in FIG. 9A. However, in this embodiment, the additional voltage coupling structure 142 is comprised of a second housing 148 coupled to a bladder 150, preferably flexible, forming a water-tight assembly with a fluid coupling passageway 152 in between. The voltage coupling plate 144 is contained within the second housing 148 and is electrically coupled to the first end 146 of the tapped coil 122 using conductor 154 which passes through a second water-tight seal 156. The voltage coupling structure 142 is preferably filled with fluid 114, e.g., de-ionized water (DI) or any hydrogen bonded liquid, using a filler tube and cap 158. While the voltage coupling structure 142 is being filled with fluid 114, air within is vented through an exhaust port 160. The voltage coupling structure 142 and specifically the bladder 150 are preferably formed as an arcuate surface 162 to match an outer surface, e.g., a curved tank or pipe, thus facilitating treatment of the solution 16 contained within. Thus, in this embodiment, the solution 16 is treated with magnetic and electric fields, respectively 20 and 22, without the delivery apparatus 140 having contact with the solution 16. As previously described, housing 72 may alternatively be fabricated from a non-conductive, e.g., PVC, or conductive, e.g., copper, material.

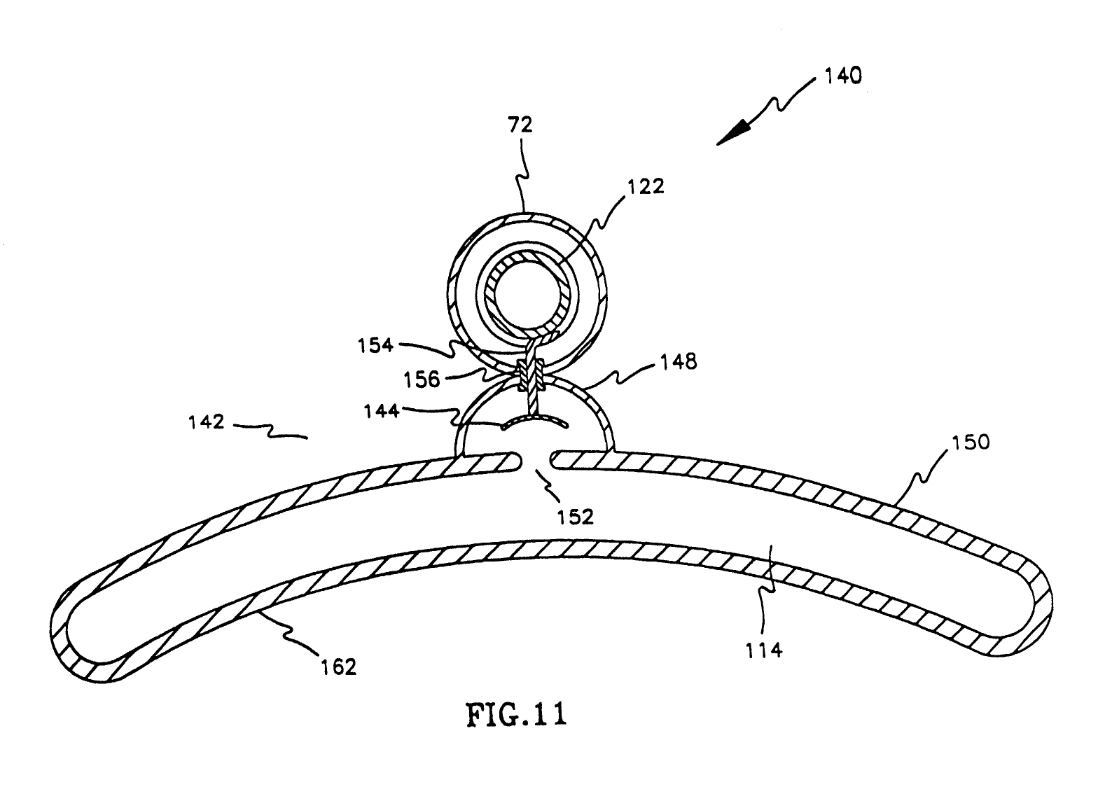

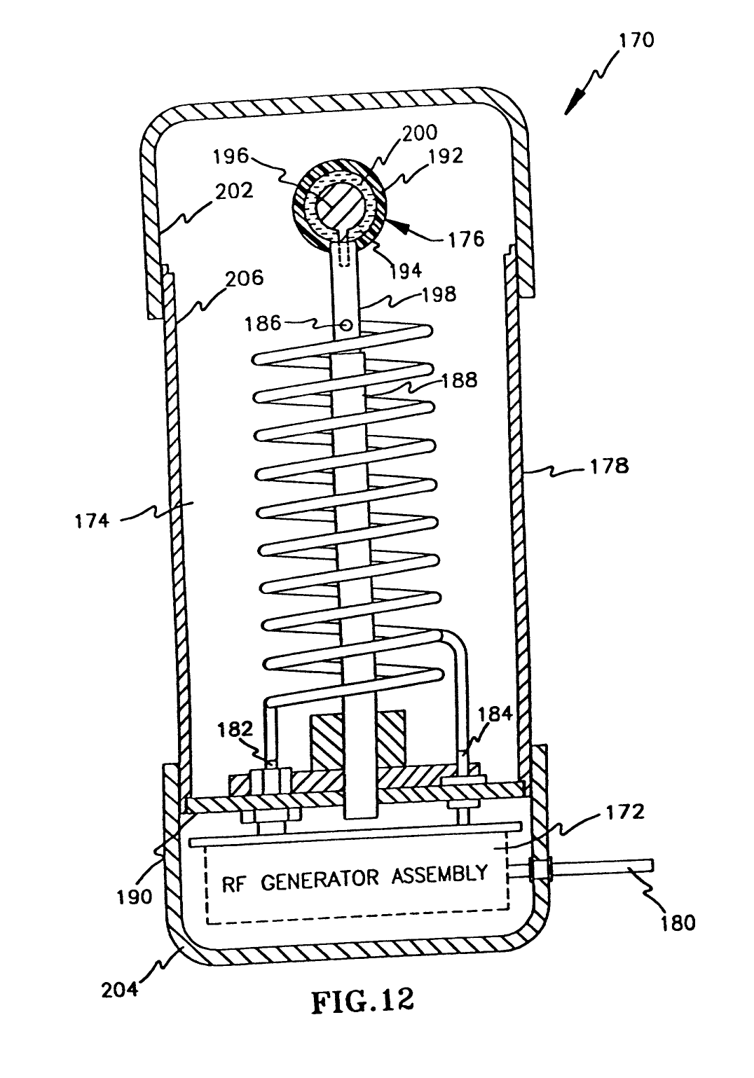

FIG. 12 shows a fourth alternative embodiment 170 of delivery apparatus 14. The delivery apparatus 170 is primarily comprised of an RF generator assembly 172, 2) a helical resonator 174, and 3) a voltage probe assembly 176, all contained within a water-tight housing 178. The RF generator assembly 172, is somewhat analogous to the previously described signal generator 12 in that it generates an RF-modulated signal. A power control cable 180 delivers modulated power, i.e., adjustable in voltage and duty cycle, to the RF generator assembly 172 to cause the RF generator assembly to deliver RF-modulated energy via conductors 182, 184 to the helical resonator 174, i.e., a tapped coil. The close proximity of the RF generator assembly 172 to the helical resonator 174 improves signal delivery. The helical resonator 174, generates a high voltage signal at its end 186 to the voltage probe assembly 176 in a similar manner to the previously described tapped coil 122. The helical resonator 174 is preferably formed of a metallic coil formed from a length of conductive wire, e.g., copper, having an unwound length of one quarter of the wavelength of the RF signal (e.g., approximately 8.62 feet @27.225 MHz). A non-conductive, e.g., polycarbonate, adjustment rod 188 is coupled to the end 186 of the helical resonator 174 and adjustably passes through end plate 190. By altering the relative position of the adjustment rod 188, the linear size of the helical resonator 174 is altered to adjust the impedance of the resonator 174 and improve signal matching to the RF generator assembly 172.

The voltage probe assembly 176 is primarily comprised of 1) a non-conductive, e.g., Teflon, outer hollow housing 192, preferably spherical, forming a matching chamber 194 within, 2) a conductive, e.g., gold-plated brass, voltage probe 196 (an electrode) contained within the housing 192, and a conductive standoff 198, coupled at a first end to the voltage probe 196, e.g., via a threaded coupling, and forming a water-tight seal to the housing 192. The second end of the conductive standoff 198 is coupled to end 186 of the helical resonator 174 providing a conductive path between the resonator 174 and the voltage probe 196. A fluid 200, e.g., de-ionized water (DI), surrounds the voltage probe 196 within the chamber 194.

The structure of the water-tight housing 178 is divided into three sections. In first and second sections 202,204 surrounding the voltage probe assembly 176 and the RF generator assembly 172, the walls of the housing 178 are formed of a non-conductive material, e.g., plastic. However, the third section 206 of the housing 178 forms a shield, preferably cylindrical and fabricated from a conductive material, e.g., copper, to contain the electrical field.

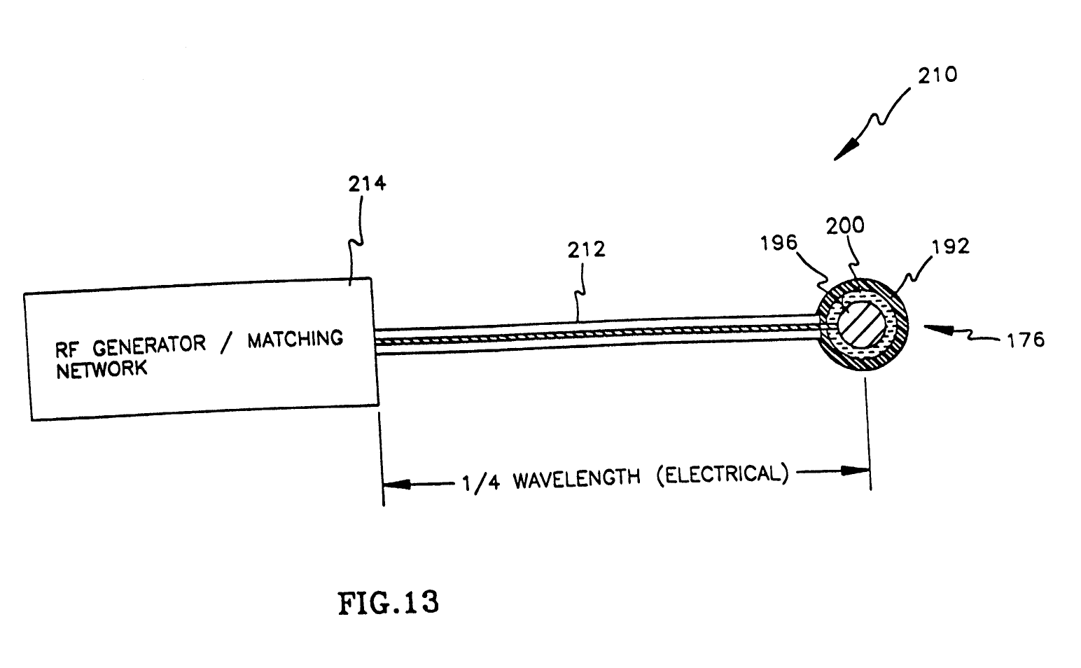

FIG. 13 shows a fifth alternative embodiment 210 of delivery apparatus 14. This embodiment is primarily comprised of the previously described voltage probe assembly 176 coupled via a shielded cable 212 having a length preferably equal to ¼ of the wavelength of the RF signal (e.g., approximately 7.9 feet @27.225 MHz and differing from the prior embodiment due to the characteristics of the cable) to an RF generator/matching network 214, similar in function and structure to the RF generator assembly 172 but physically remote from the voltage probe assembly.

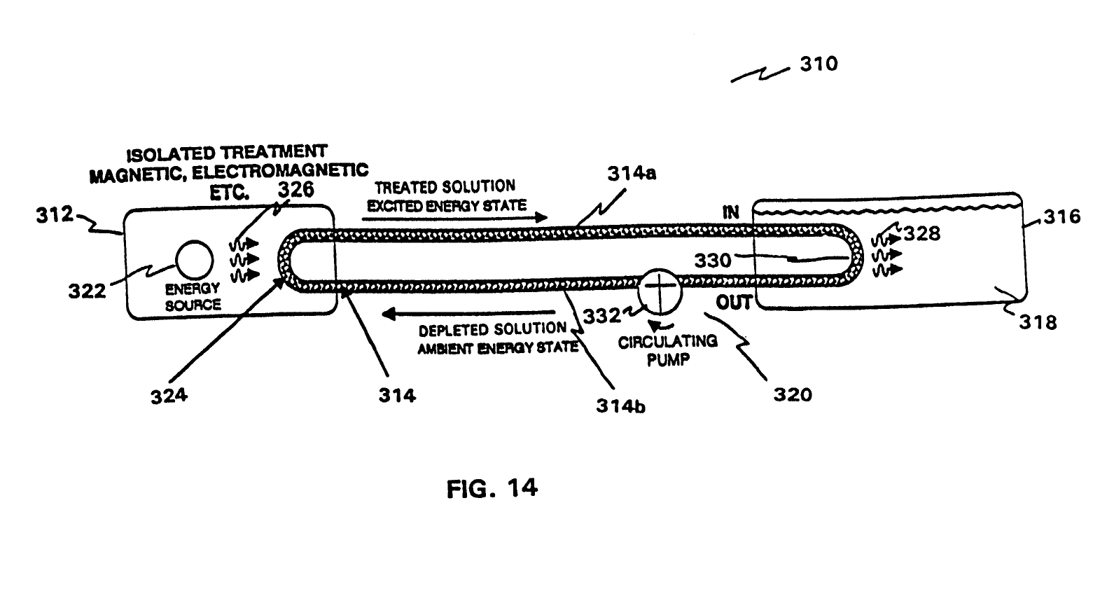

FIG. 14 shows a block diagram of a treatment system 310 that embodies the present invention, primarily comprised of: 1) a treatment station 312 located at a first location for treating a primary solution 314 (e.g., water), 2) a process station 316 located at a second location containing a secondary solution 318 that is to be treated, i.e. a target solution, where the process station 316 is preferably located remote from the treatment station 312, and 3) a transporting apparatus 320 for transporting the treated primary solution 314 proximate to the to the secondary solution 318. The treatment station 312 preferably contains a delivery apparatus 322 for generating electromagnetic energy and treating the primary solution 314. (In this application the term “remote” is intended to describe the process where the treatment of the primary solution occurs at a location separated from the predominant location of the secondary solution at the process station 16, i.e., the delivery apparatus is not located at the process station 16.) An exemplary delivery apparatus 140 (see FIG. 11) delivers electromagnetic energy into an energy receiving primary solution (see fluid 114 in FIG. 11 comprised of de-ionized water or any hydrogen bonded liquid) contained within the bladder 150 preferably surrounding a pipe 324 (see FIG. 14). The primary solution 314 contained within the pipe 324 receives radiation 326 which modifies the primary solution 314. Consequently, the primary solution 314 can then emit secondary radiation 328 (actually tertiary radiation relative to the original radiation into the energy receiving primary solution 114) to treat the secondary solution 318 from a radiator loop 330.

The primary solution 314 is preferably recirculated between the treatment station 312 and the process station 316 by passing the primary solution 314 within the pipe 324 using an apparatus for maintaining flow of the primary solution, e.g., a circulating pump 332. Although, it is preferable to recirculate the primary solution 314, it is not necessary to practice the present invention. Embodiments which unidirectionally transport the primary solution 314 from the treatment station 312 to the process station 316 are also considered within the scope of the present invention. Embodiments which recirculate the primary solution are believed to be more efficient. Not all of the energy delivered into the primary solution 314 can be imparted to the secondary solution 318 when solution 314a is transported proximate to the secondary solution 318. Thus, the primary solution 314 will still retain some of the RF-modulated energy imparted to it by the delivery apparatus 322. Consequently, by recirculating the partially depleted primary solution 314b back to the delivery apparatus, it will take less energy to re-treat the primary solution 314b.

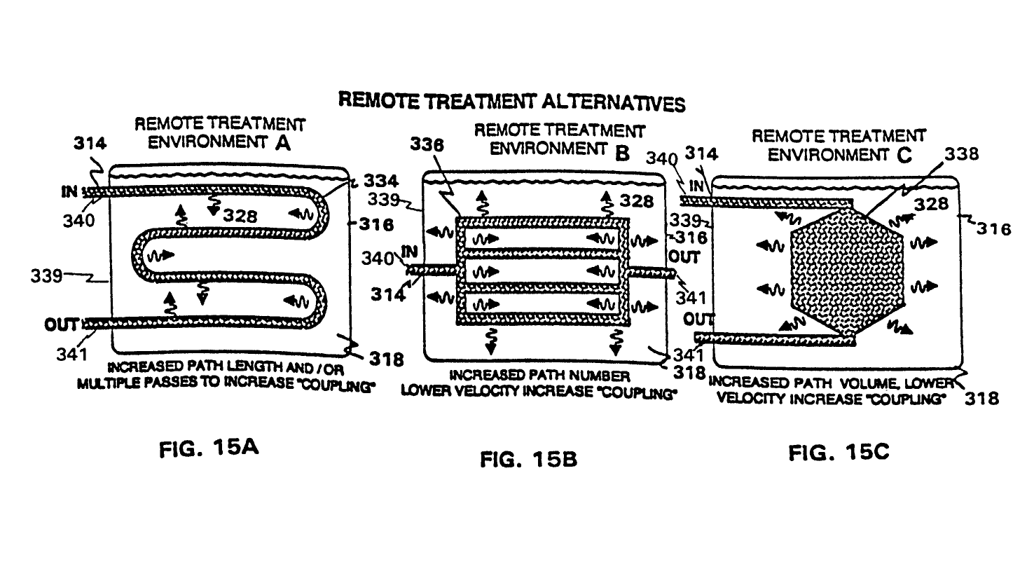

The extent of treatment of the secondary solution is somewhat dependent upon the proximity and duration of exposure of the primary solution 314 to the secondary solution 318. FIGS. 15A-15C show exemplary radiators 334, 336, 338 for exposing the secondary solution 318 to radiation 328 from the primary solution 314. Radiator 334 comprises an extended radiator loop 330, i.e., a tubular portion, extending through a peripheral wall 339 of the process station 316 which is used for passing primary solution from an inlet port 340 to an outlet port 341. This structure increases the coupling, i.e., the efficacy of treating the secondary solution from the primary solution, due to its increase in path length and/or having multiple passes as compared to the single loop of the radiator loop 330 implementation. Radiator 336 increases the number of paths and thus the volume of the secondary solution 318 being directly treated by secondary emissions 328 from the primary solution 314. However, due to the increase in the number of paths, the solution's velocity is correspondingly decreased. This decrease in velocity exposes the secondary solution 318 to each portion of the primary solution 314 for a longer period of time. Radiator 338 exposes a larger volume by having a large cross-sectional surface area (e.g., a hexagon as shown in this example) that also enables a large volume of secondary solution to be directly subjected to secondary radiation 328 from the primary solution 314. Again, this increased exposure area results in a lower velocity for the primary solution 314 within the radiator 338. One of ordinary skill in the art can envision other radiator configurations that trade off the amount of exposure and the velocity of the primary solution 314.

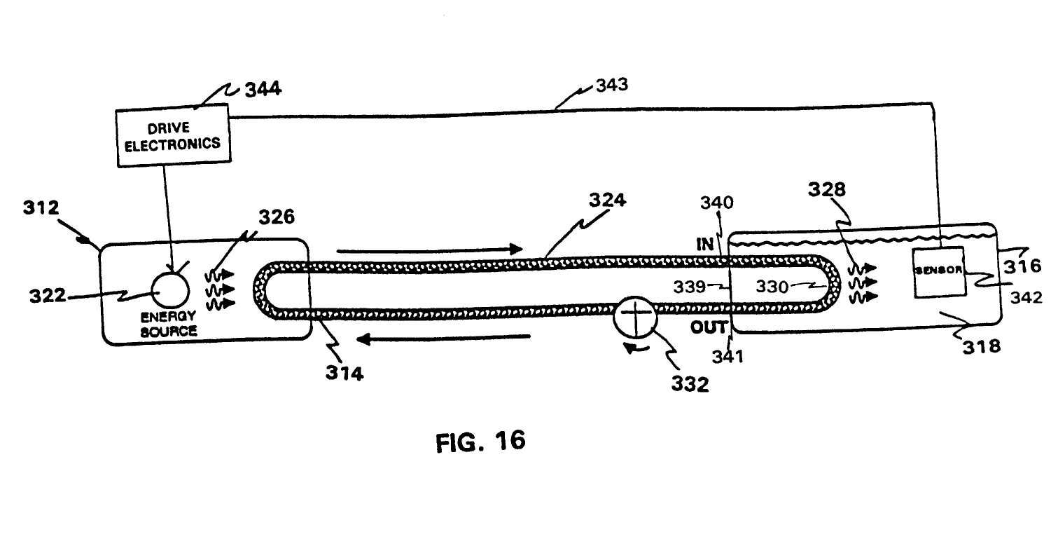

As disclosed above, a feedback mechanism is preferably used to determine the optimal treatment level for the solution. In the present invention, it is the treatment level of primary solution 314 that is preferably modified in response to secondary effects of treating the secondary solution 318. Therefore as shown in FIG. 16, a sensor 340 is preferably placed in the secondary solution 318 and coupled via feedback signal 342 to drive electronics 344 (for example, see signal generator 12 in FIG. 6) which drives the delivery apparatus 322. The sensor 340 can alternatively measure pH, zeta potential or any other characteristic that determines the amount of treatment required. As described above, the drive electronics 344 can alter the duty cycle, frequency, amplitude, etc. of the RF-modulated energy applied to the delivery apparatus 322. Additionally, the recirculation speed of the primary solution 314 can be altered by changing the speed of the circulating pump 332 in response to the feedback signal 342. Although placing the feedback sensor 340 in the secondary solution 318 is preferred, feedback control can also be achieved with a feedback sensor placed in the primary solution 314 (which corresponds to the amount of treatment of the secondary solution 318).

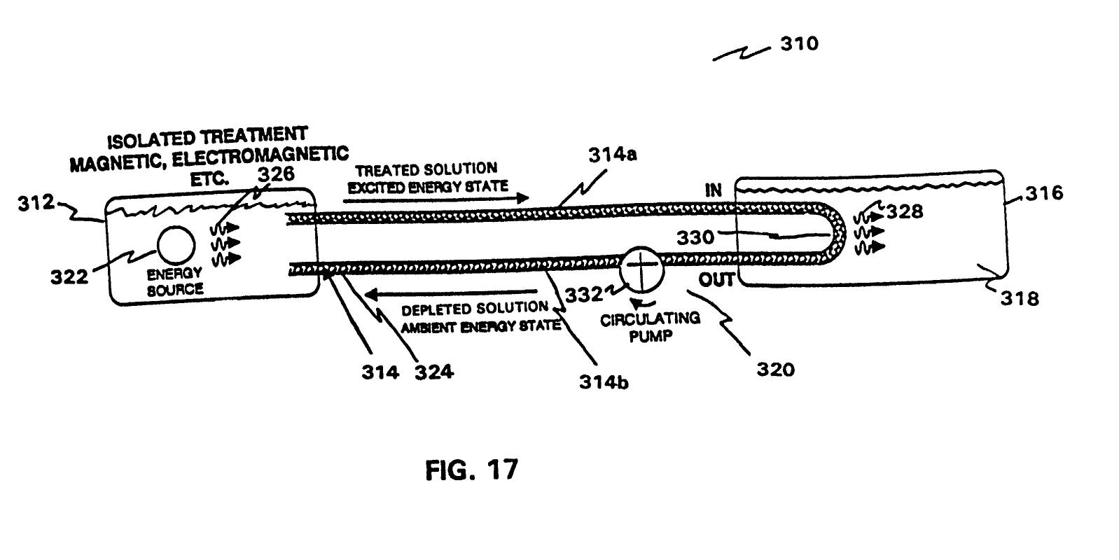

While it is preferable to recirculate a primary solution 314, e.g water or any hydrogen bonded liquid, which is isolated from the secondary solution 318 between the treatment station 312 and the process station 316, any system that transports a solution between stations 312 and 316 to facilitate treatment by secondary emissions is considered to be within the scope of the present invention. FIGS. 17-20 are exemplary embodiments of systems that treat a secondary solution 318 causing the treated primary solution 314 to be located proximate to the secondary solution 318.

For example only, FIG. 17 shows a treatment system 310 where the primary solution 314 is contained within treatment station 312. The treated primary solution 314 is recirculated in pipe 324 between the treatment station 312 and the process station 316 where the secondary solution 318 is treated. In this example, the primary 314 and secondary 318 solutions are isolated from each other.

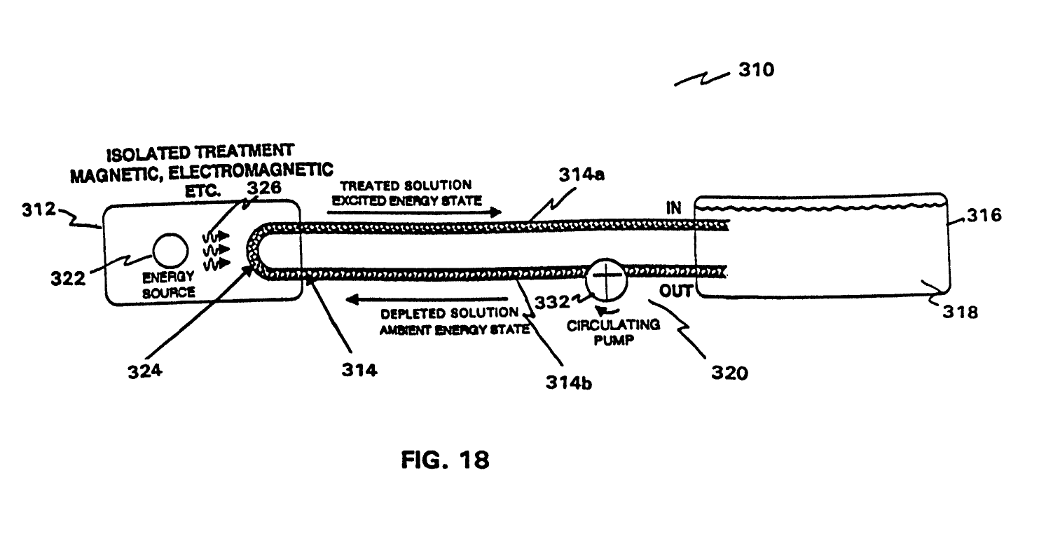

Conversely, FIG. 18 shows a treatment system 310 where the secondary solution 318 is recirculated in pipe 324 between the process station 316 and the treatment station 312. At the treatment station 312, the secondary solution 318 treated by secondary emissions from a primary solution 314. In this example, the primary solution 314 is alternatively contained within a tank in the treatment station 312 or is the solution contained within the delivery apparatus 322 (e.g., see fluid 114 in FIG. 11 comprised of de-ionized water or any hydrogen bonded liquid). In either case, the primary 314 and secondary 318 solutions are isolated from each other.

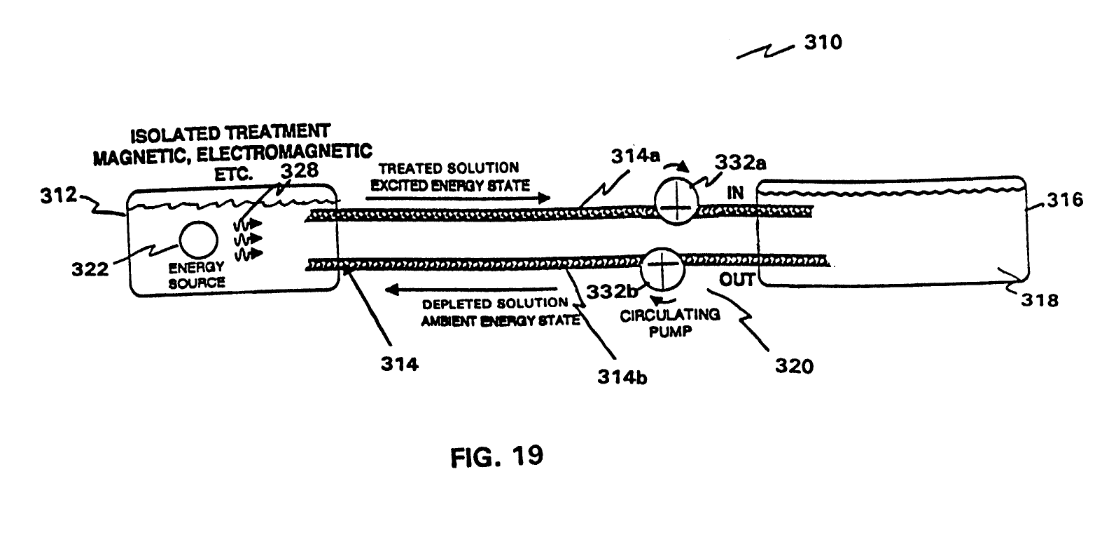

FIG. 19 shows a treatment system 310 where the secondary solution 318 is passed bidirectionally between the process station 316 and the treatment station 312 using a pair of circulating pumps 332a and 332b. In this example, the primary solution 314 is the solution contained within the delivery apparatus 322 (see fluid 114 (DI or any hydrogen bonded liquid) in FIG. 11), isolated from the secondary solution 318. The treated secondary solution within the tank at the treatment station 312 is mixed with untreated secondary solution within the tank at the process station 316 and consequentially treats the remaining secondary solution.

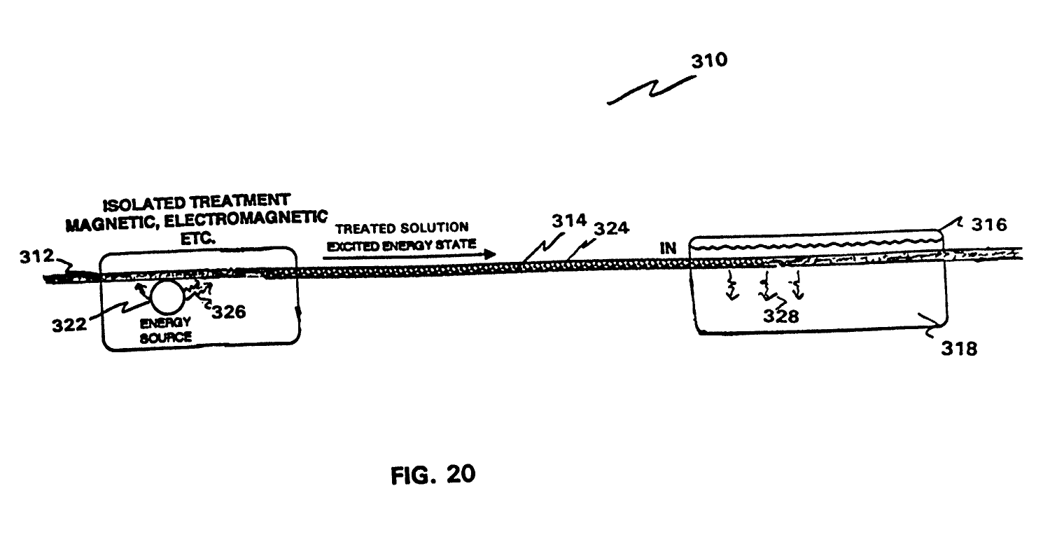

FIG. 20 shows a treatment system 310 where a primary solution 314 passes unidirectionally from the treatment station 312 where it is treated using the delivery apparatus 322 with electromagnetic energy to the process station 316 where secondary solution 318 is treated with secondary radiation 326 from the primary solution 314.

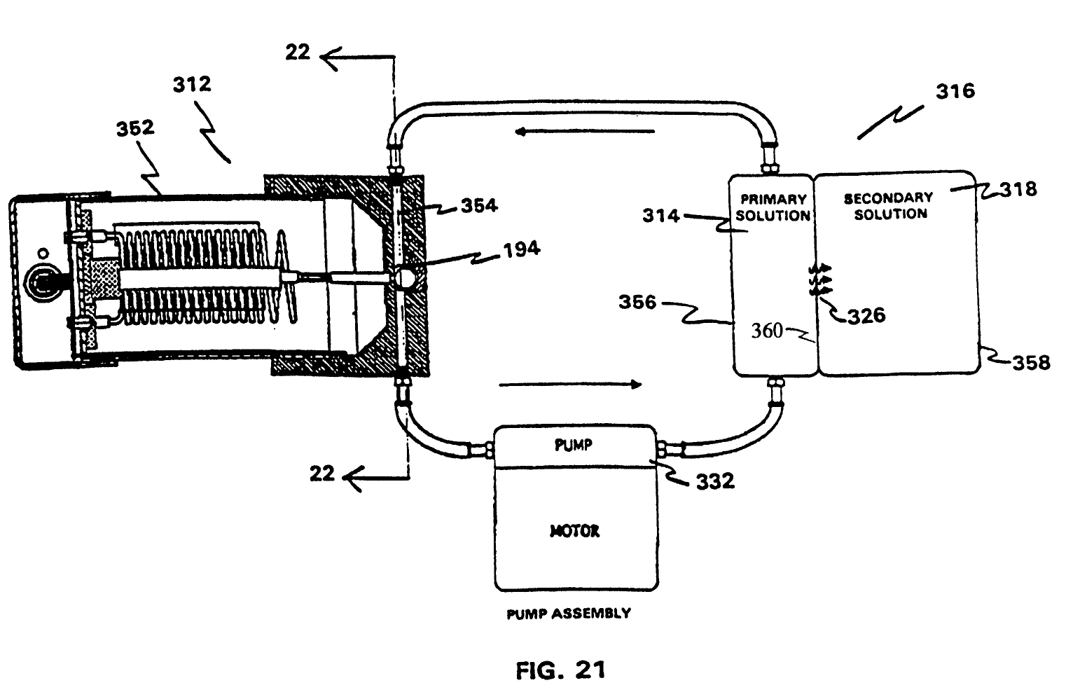

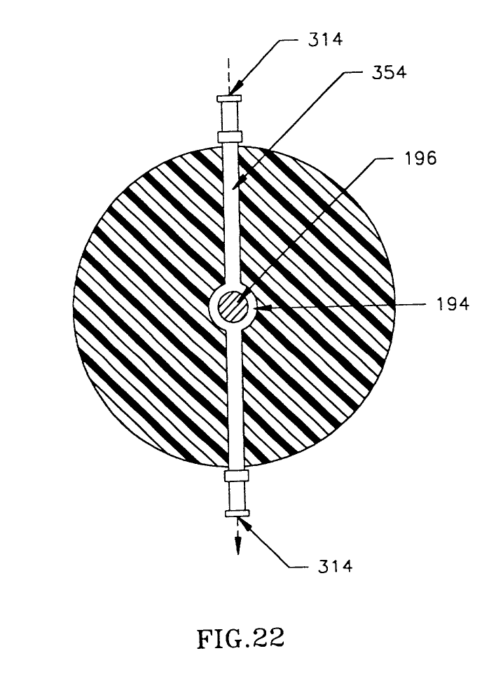

FIG. 21 shows an exemplary system 350 for treating a target solution. In this system, a delivery apparatus 352 similar to that described in reference to FIG. 12, is modified to permit a recirculation pipe 354 to pass the primary solution 314, e.g., water or any hydrogen bonded liquid, through chamber 194 surrounding the voltage probe 196. (See FIG. 22 for a cross sectional end view of the delivery apparatus 352 to see the relationship between the recirculation pipe 354 and the chamber 194). As previously described, the voltage probe 196 supplied electromagnetic, preferably RF-modulated, energy which treats the surrounding solution in the chamber 194. However, in this embodiment the surrounding primary solution 314 recirculated through pipe 354 using the circulating pump 332. The recirculated primary solution 314 is circulated through a remote primary solution tank 356 (somewhat analogous to previously-described radiator loop 330 except that the voltage probe/electrode 196 is in direct contact with the primary solution 314) The primary solution tank 356 is located in close proximity to a process solution tank 358 which contains the primary solution 318. In this embodiment, the combination of the primary solution tank 356 and the process solution tank 358 form the process station 316. Due to the quantity of treated primary solution 314 being present in the primary solution 356 and its proximity to the process solution tank 358, sufficient secondary radiation 326 can remotely treat the secondary solution 318 in the process station 316 by passing secondary radiation 326 through a barrier 360 between tanks 356 and 358. Although FIG. 21 shows two separate tanks proximate to each other, it is recognized that embodiments of the present invention include single tanks that have separate, i.e., isolated, compartments for containing the primary solution 314, i.e., the recirculated treated solution, and the secondary solution 318, i.e., the solution that requires treatment.

It has been disclosed that secondary radiation from a treated primary solution can modify the characteristics of a secondary solution placed in close proximity. Additionally, has been disclosed that shielding can effect this transfer of secondary radiation. Therefore, it is believed to be preferable to shield the portions of the pipe 324 between the treatment station 312 and the process station 316 (see FIG. 16) that contain the recirculated treated primary solution as well as the treatment station 312 and the drive electronics 344 to limit the exposure by secondary radiation of any additional solutions that might be located proximate to the treatment system 310. Preferably, metallic or metallic composite shields are used to limit the effects of the secondary radiation. Alternatively, portions of the pipe 324, the treatment station 312 and the process station 316 can be formed from metallic substances, e.g., metals or metallic composites. Since metallic shields limit the effects of secondary radiation, it is also preferable that the barrier 360 (see FIG. 21) be formed from a non-metallic substance, e.g., plastic, and not shielded so that the secondary radiation 326 can pass from the primary solution 314 in tank 356 to the secondary solution 318 in tank 358. Similarly, radiator portions 330, 334, 336 and 338 (and portions of pipe 324 located within the treatment station 312 shown in FIGS. 14, 16, 18 and 20) are also preferably formed from non-metallic substances not substantially limit passage of secondary radiation 328.

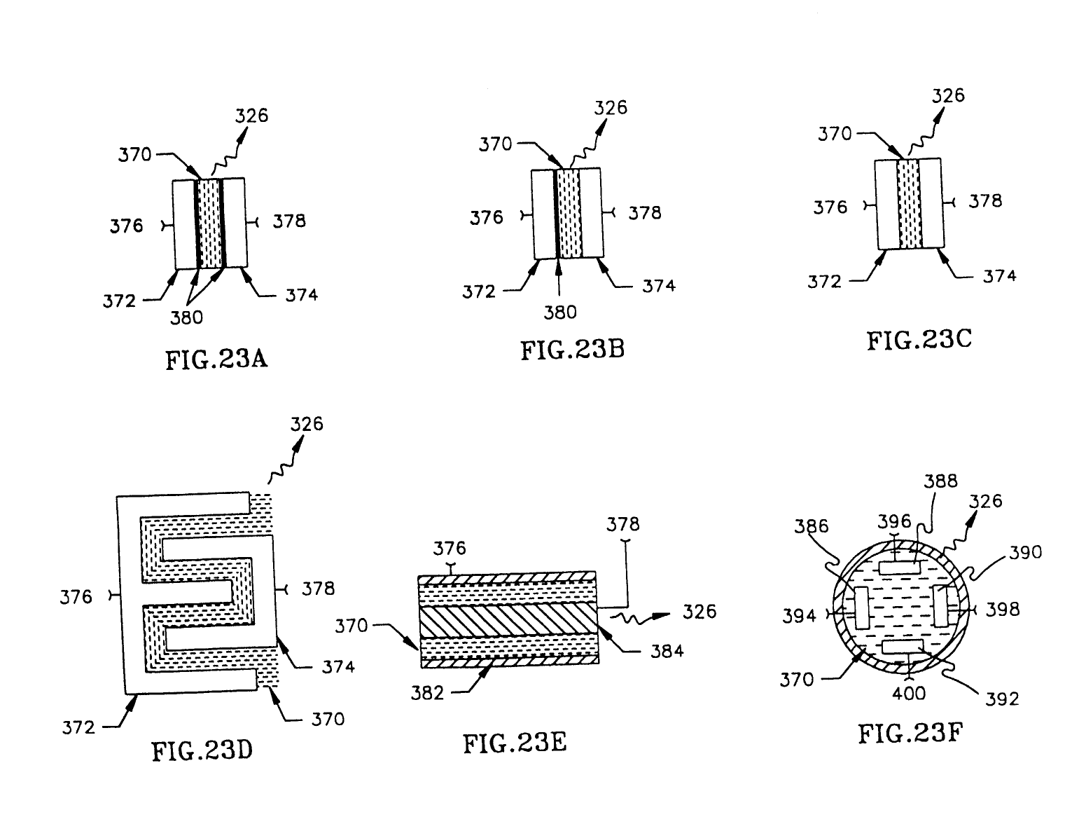

While the presently-preferred embodiments of delivery apparatus have been described above, FIGS. 23A-23F show additional design criteria that can be used in constructing additional delivery apparatus that treat a fluid, i.e., primary solution 314 (e.g., water or any hydrogen bonded liquid), that is then used to treat a secondary solution 318.

In FIG. 23A, a fluid 370 is contained or circulated between two metallic plates 372 and 374 independently driven by electromagnetic, preferably RF-modulated, signals 376 and 378. Each plate is preferably covered with a thin dielectric coating 380 such that there is no galvanic connection between fluid 370 and the metallic plates 372 or 374.

In FIG. 23B, the fluid 370 is contained or circulated between the two metallic plates 372 and 374 independently driven by electromagnetic signals 376 and 378. In this embodiment, only one plate, e.g., 372, is covered with a thin dielectric coating 380 such that there is a galvanic connection between the fluid 370 and one metallic plate, e.g., 372. only.

In FIG. 23C, the fluid 370 is contained or circulated between the two metallic plates 372 and 374 independently driven by electromagnetic signals 376 and 378. However, in this embodiment, neither plate is coated with a dielectric coating and thus each plate has a galvanic connection to the fluid 370.

In FIG. 23D, the fluid 370 is contained or circulated in a serpentine fashion between the two metallic plates 372 and 374 independently driven by electromagnetic signals 376 and 378. In this embodiment, the surface area of metallic plates, proximate to the fluid 370, is extended to increase exposure of the fluid 370 to RF-modulated energy from signals 376 and 378. The metallic plates and may have coatings as described in reference to FIGS. 23A-23C.

In FIG. 23E, the fluid 370 is contained or circulated through a conductive tube or pipe 382 having a center electrode 384. The conductive pipe 382 and the center electrode are independently driven by electromagnetic signals 376 and 378. The conductive pipe 382 and the center electrode 384 may have coatings as described in reference to FIGS. 23A-23C.

In FIG. 23F, the fluid 370 is contained or circulated between multiple metallic plates 386, 388, 390 and 392 independently driven by electromagnetic signals 394, 396, 398 and 400. The metallic plates may have dielectric coatings as described in reference to FIGS. 23A-23C. Two or more of the electromagnetic signals are preferably phase shifted to create a rotating electric field in the fluid 370.

As disclosed above, the characteristics of a solution, e.g., a fluid or gas, can be desirably altered by treating a solution with RF-modulated energy. It has been shown that the effects of treating a solution with RF-modulated energy endure for a substantial period of time, i.e., minutes as opposed to microseconds. Thus, further experimentation proceeded to determine any additional aspects of this treatment. Consequently, it was determined that if a first solution, i.e, a primary solution such as water, de-ionized (DI) water or any hydrogen bonded liquid, is treated and subsequently transported to a remote location and placed in close physical proximity to a secondary solution, the characteristics of the secondary solution are similarly effected, e.g., secondary emissions from the primary solution effect the characteristics of the secondary solution. The following experiments were conducted:

“Primary” water which had been treated in the above-described manner from the radio frequency source was placed in proximity to, but physically separate from, untreated samples of similar “secondary” water within a shielded environment. Shielding was accomplished in each case by placing the treated and untreated samples near each other, either within a Mu-metal box or within a copper-clad room from which all electrical equipment had been removed, thereby eliminating “noise” from any external radiation sources present in the environment. The Mu-metal boxes had ports for probes, such as pH probes, shielded loops, or other equipment to remotely measure the effects of treatment on the secondary water, for passing primary treated water through the box within a sealed loop of elastomeric tubing. Several Mu-metal boxes were used, some of them for actual treatments and others in a “mock” treatment mode to create control samples. The mock treatments were accomplished in the same way as the actual samples using an identical apparatus, but were run without operating the radio frequency source.

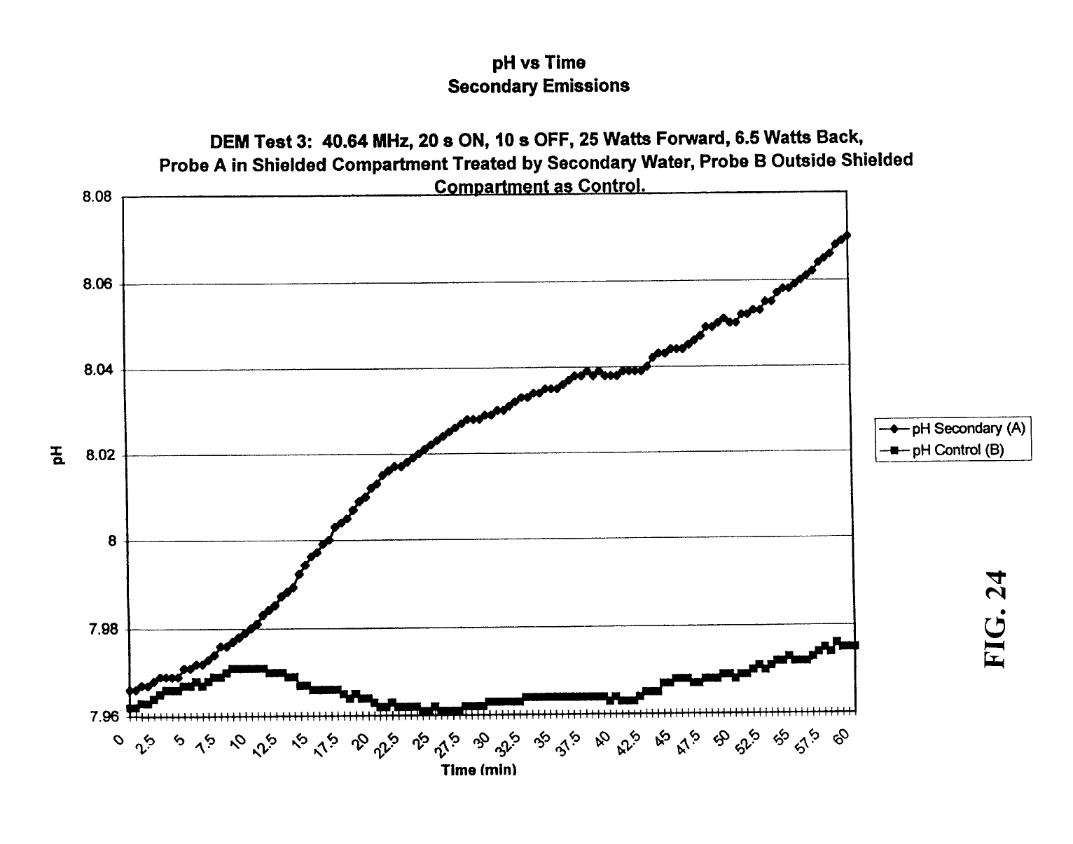

With reference to FIG. 24, the changeover time in the pH of a beaker of secondary water through which primary, radio frequency-treated water was passed as illustrated. The primary water was passed at a rate of 750 ml/min., using a peristaltic pump, within a sealed loop of ⅛-inch inner diameter Tygon tubing. The primary water was treated by exposure to the radio frequency source for a total of thirty minutes at a frequency of 27.4 MHz, an amplitude of approximately 20,000 volts and a duty cycle of fifteen seconds “on” and fifteen seconds “off”. Exposure of the secondary water to the primary water took place in a Mu-metal box without mixing the two samples. The results are compared in FIG. 14, with the relatively constant pH of the “control” sample (lower curve) exposed only to untreated water. The pH of the secondary water sample exposed to radio frequency-treated water increased substantially over a period of approximately seventy minutes, demonstrating that energy was being transferred from the primary water to the secondary water. Periodic fluctuations in the rising pH are believed to be attributable to the manner in which the pH effect propagates within the secondary sample as it receives energy from the primary, radio frequency-treated water.

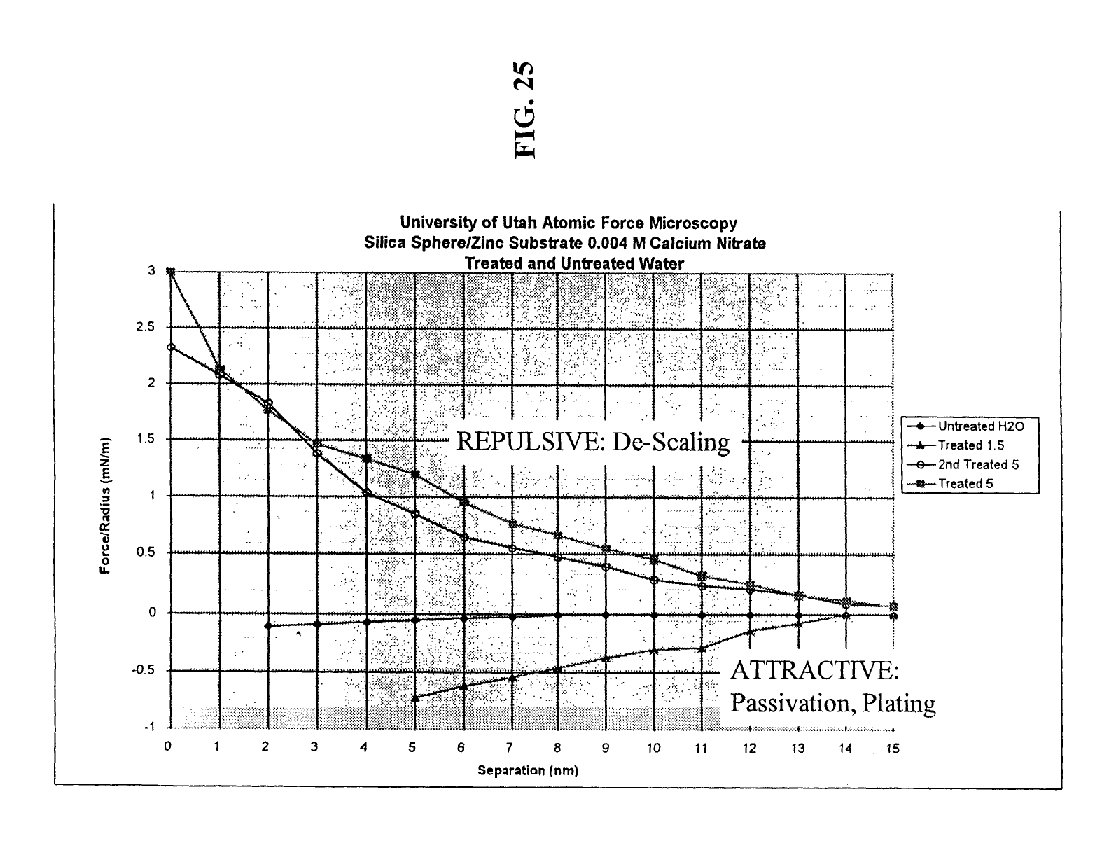

Referring now to FIG. 25, the results of atomic force microscopy on three different secondary samples of triply-distilled deionized water which were exposed to primary, radio frequency-treated water, as well as a control sample process without radio frequency treatment is illustrated. In each case of radio frequency treatment, the primary sample was exposed to the radio frequency source for thirty minutes with an on-off duty cycle of fifteen seconds, under conditions similar to that described in Mechanism of the Long-Term Effects of Electromagnetic Radiation on Solutions and Suspended Colloids, Langmuir 1998, 14, 783-787, by Colic and Morse; and Effects of Amplitude of the Radio Frequency Electromagnetic Radiation on Aqueous Suspensions and Solutions, Journal of Colloid and Interface Science 200, 265-272 (1998) by Collic and Morse. The attractive and repulsive forces, expressed as Milli-Newtons per meter (Mn/M), are recorded as the silica spheres approach the zinc substrate. The measurements were conducted at the Atomic Force Microscopy Lab of the University of Utah, using silica spheres and a zinc substrate in a 0.004 M Calcium Nitrate Solution. The curve formed by the solid squares illustrates the repulsive forces created in water directly treated with the radio frequency source under high field (5.0 V at probe) conditions, whereas the curve formed by solid triangles illustrates the attractive forces created in water directly treated with the source under low field (1.5 V at probe) conditions. The curve formed by solid diamonds represents the absence of attractive/repulsive forces in the untreated control sample. Finally, the curve formed by open circles illustrates the repulsive forces created in a secondary solution of 0.004 M. calcium nitrate exposed only to a comparable solution that had been exposed to the radio frequency source under the high field conditions described above. Exposure was achieved by placing a 1 liter beaker of the secondary solution in close proximity (1 cm) to the directly treated solution within a Mu-metal box for 30 minutes. The data of FIG. 25 demonstrates that the effect of direct radio frequency treatment on attractive/repulsive forces depends, at least in part, on the magnitude of the treating signal, and that a directly-treated solution radiates energy capable of creating similar repulsive forces in a separate solution proximate to it.

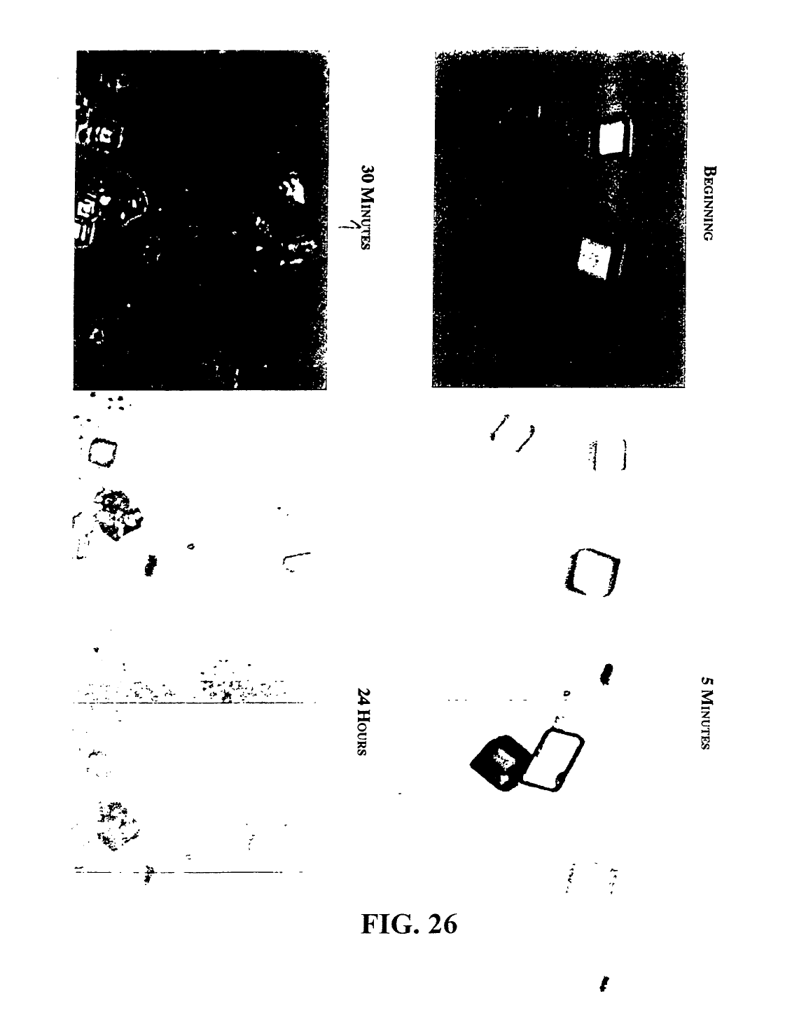

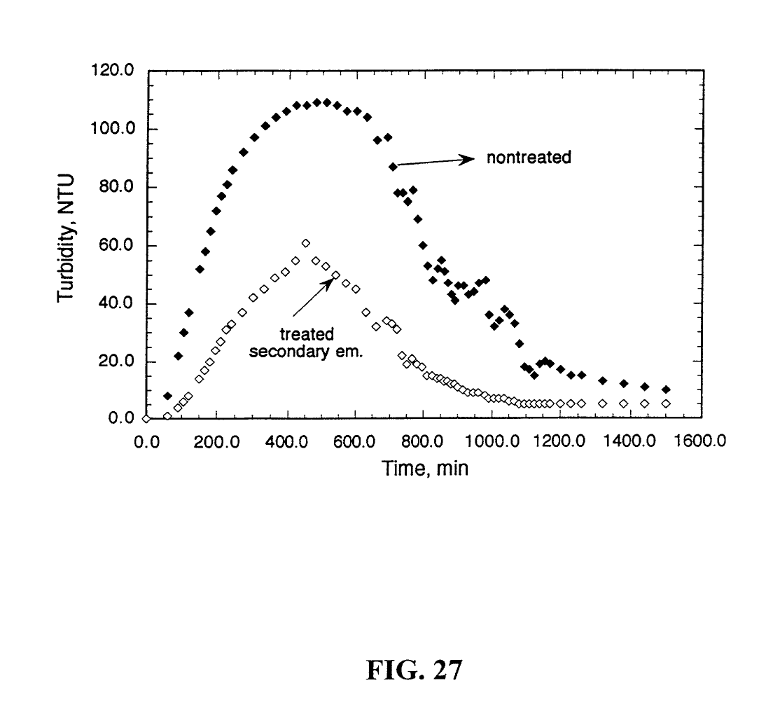

With reference now to FIGS. 26 and 27, the effect of crystal formation using the present invention is shown. A secondary one liter solution containing both five MM calcium nitrate and five mM sodium carbonate was placed in proximity to water treated by direct exposure to the radio frequency sources described above. The primary directly-treated water and the secondary solutions were placed immediately adjacent one another in a Mu-metal box for a period of twenty-four hours, during which samples were removed periodically to examine crystal formation, both photovideographically and by turbidity measurements. An identical experiment was conducted with untreated water as a control.

FIG. 26 illustrates four photovideographs, taken at the 0 minute, 5 minute, 30 minute and 24 hour points, of the solution exposed to the radio frequency-treated water. An Olympus scope (Model MJ having dark and bright field capacity, polarizers and substage illumination) was used with a Panasonic color CCD video camera (Model CP410) to detect and record the images. The photovideographs illustrate the conversion of well-defined calcite crystals into more fractured, less-defined aragonite crystals over the duration of the experiment. The control, which is not shown, did not change perceptibly.

FIG. 27 illustrates the results of turbidity measurements on the same solutions in graphical form. These measurements demonstrate that the secondarily-treated solution (open diamonds) had far less turbidity than the untreated control solution (solid diamonds). The units of the turbidity data are nephelometric units (NTU).

The photovideographic evidence of FIG. 26 and the turbidity measurements of FIG. 27 demonstrate that scale-forming crystalline deposits take longer to form when the specified solution has been exposed to radiation emanating from radio frequency-treated water. The turbidity evidence is especially compelling because it does not perturb or interact with the sample in any way. The measurement is completely non-invasive, and yet demonstrates that the secondary effect lasts for many hours.

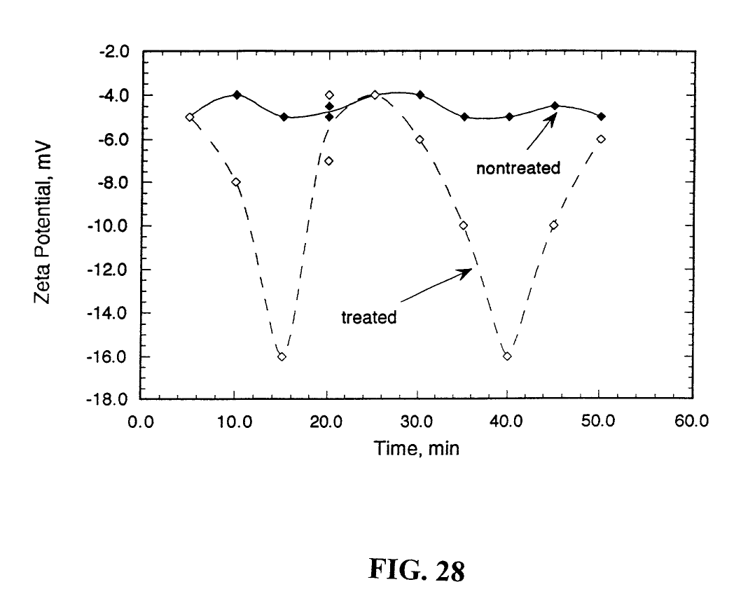

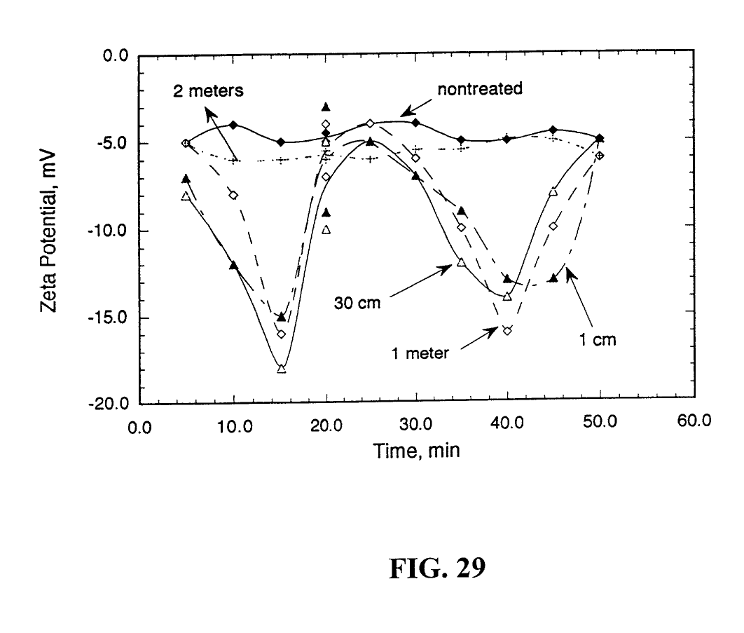

FIGS. 28 and 29 illustrate the effect of secondary treatment by a body of radio frequency-treated water on the zeta potential of a secondary solution. In each case, 1 liter polypropylene beakers of air-saturated 0.001 M sodium chloride solution containing 20 mg of titanium dioxide (rutile) (pH 6.6) was placed in a Mu-metal box with a 1 liter beaker of water treated by radio frequency energy in a manner described above for zeta potential measurement. The rutile is self-buffering and, together with carbon dioxide, determines the aqueous pH of the solution. Under normal ambient conditions for untreated water, the zeta potential of such a solution is nearly zero. A similar experiment was conducted with untreated water for control.

FIG. 28 shows a dramatic change in zeta potential for a secondary solution placed very near (1 cm) the radio frequency-treated water, and FIG. 29 shows the zeta potential profiles of secondary solutions placed 1, 30, 100 and 200 cm from the treated water. As seen from the graph, the effect is achieved over substantial distances but decreased significantly at a separation of 200 cm (2 m). However, it has been shown that desired effects can be achieved at distances in excess of 3 meters.

In another experiment, solution p (primary) was treated by delivering a high voltage electromagnetic signal into a container holding solution p comprised of water. A portion of the treated solution p was then transported to another room which was approximately 50 feet away and placed in a bottle which was placed near a beaker which contained a solution s (secondary) of nitric acid. A pH electrode was located in the secondary beaker during this experiment. Before placing solution p near the beaker with solution s, the pH was constant at 4.341±0.002 for at least 30 minutes. Fifteen minutes after placing solution p near the beaker with solution s, the pH was fluctuating and afterwards started to continuously drift downwards, changing to a pH of 4.128 after 2 hours of exposure. This experiment was repeated three times.

In a similar experiment, 20 mg of rutile was placed in a beaker (solution s). After 24 hours, its zeta potential was measured. The zeta potential remained at 7±2 mV for at least one hour. After that, a container of solution p (water) which had been treated with a high voltage electromagnetic signal was placed in a bottle near solution s. The zeta potential of rutile in solution s started to fluctuate between 22 and 6 my with time after exposure, i.e., being placed in close proximity to solution p. This fluctuation persisted for at least 2 hours. Atomic force microscopy was used to measure the surface forces at the atomic interface of zinc colloids and a solid silica surface. A non-energized solution (solution s) consistently exhibited positive force vectors out to a distance of 30 nanometers from the surface. The same solution was exposed to bottles of treated water (solution p) for a period of 20 minutes and the force vectors reversed their direction, becoming negative up to 9 nanometers, where it remained at 0 out to a distance of 100 nanometers.

In another experiment, tap water was placed into two glass beakers (#1 and #2) of equal diameter. The water content in each beaker was measured and equalized to 100±0.11 grams. While, beaker #1 was kept isolated from the treated water, beaker #2 was exposed (e.g., by secondary emissions) to treated water (solution p). Both beakers were allowed to stand and their weight was measured at 1 hour intervals in two controlled environments (30° C. with no ventilation but open to the atmosphere) Beaker #1 (the untreated beaker) lost weight at 1.84 times the rate of beaker #2. The experiment was repeated ten times in three hours with results repeating within ±3%.

In yet another experiment, surface tension was recorded with secondary water and oscillations occurring from 75 mN/m (millinewtons/meter) to 77.5 mN/m.

In yet another similar experiment, a precipitation of calcium carbonate was measured by measuring its turbidity upon mixing 10 ml of 0.003 M calcium nitrate and 10 ml of 0.005 M sodium carbonate. The turbidity first increased and after reaching a plateau decreased with time (e.g., a nucleation and precipitation reaction). In a next experiment, the solutions of calcium nitrate and sodium carbonate (solution s) were exposed to a similarly treated solution p (water) for a period of ten minutes prior to mixing. The maximum turbidity was observed to decrease significantly in the presence of secondary emissions. Particles precipitated under exposure to solution p exhibited a larger mean particle size (as measured by optical microscopy).

The effects of shielding barriers on secondary emissions from solution p were also studied. From these studies it was determined that it was preferable to use a metallic shield, e.g., copper, p metal, etc., to limit the secondary emissions from treating any solutions other than the secondary solution.

To evaluate the strength of the secondary emissions, pH was again measured versus time in solution s. In one experiment, solution p (water) was treated with electromagnetic energy and a bottle in which solution p was contained was enclosed in three sheets of aluminum foil. The pH of solution s held constant at 4.349±0.002 for at least 30 minutes. After placing a bottle with solution p nearby, the pH of solution s changed from 4.349 to 4.193 in 2 hours. This experiment was repeated three times with a reproducibility of ±0.01 pH units.

In yet another experiment, the bottle with treated solution p (water) was placed inside an aluminum container with ⅛ inch thick walls. The pH of solution s was initially constant at 4.160, but 1 hour after placing solution p nearby (inside a container) it changed to 4.195 and it continued to increase.

In yet another experiment, the bottle with treated solution p (water) was placed inside a stainless steel container with ⅛ inch thick walls. The pH of solution s was constant at 4.420. After solution p inside the container was placed nearby, the pH of solution s changed from pH 4.420 to 4.469.

From these experiments, it was concluded that a mechanism existed where once a primary solution, e.g., water or any hydrogen bonded liquid, was treated with electromagnetic radiation, e.g., from within an RF frequency band, that transporting/moving the primary solution proximate to a secondary solution (or moving the secondary solution relative to the primary solution) could treat the secondary solution, e.g., by secondary emissions from the primary solution.

In the examples listed above, the primary solution was subjected to radio frequency using the devices and systems described above. It has been found that the initial level applied to the primary solution can range from five to thirty kilovolt electric fields, with the radio frequency device set at between 12 Hz to 325 GHz, but preferably 27 MHz, and an EM between 60 Hz and 2450 MHz. As described above, the relative distance of the primary and secondary target solution has been found to impart results at anywhere between 0 and 3 meters. Of course, the closer the relative distance between the primary and secondary solution, the greater the energy transfer and impact upon the target secondary solution.

However, while the generation of an electromagnetic field utilizing a radio frequency device is preferred, the invention is limited to such. An experiment was conducted in which test tubes containing untreated water within beakers of water which had been stimulated by various energy sources to measure the growth of plants germinated from seeds within the test tubes. A total of 48 test tubes, each having a capacity of 55 milliliters, were filled with untreated water drawn at one time from a single municipal tap. A ball of fibrous material, made of sterile polyester fiber, available commercially from Federated Group Incorporated of Arlington, Heights, Illinois under the name “Hy-Top Cosmetic Puffs”, was fitted to the upper end of each test tube in contact with the water so that the puffs remained moist. Four seeds, all of one type (barley, raddish or wheat), were placed on the moist puff of each test tube with forceps so that sixteen test tubes contained barley seeds, sixteen others radish seeds, and the final sixteen contained wheat seeds. Each set of sixteen test tubes was then divided between four one-quart mason glass jars, so that four test tubes containing similar plant seeds were maintained in a vertical position in each jar. The individual test tubes within each jar were labeled for reference.

Each of the four jars used to hold the test tubes containing a specific type of seed was filled with tap water and treated either by (1) exposure to static magnetic field; (2) exposure to microwave energy; (3) exposure to an electric current; and (4) absence of treatment for uses in experimental control. The jars were shielded from one another by wrapping aluminum foil around each jar.

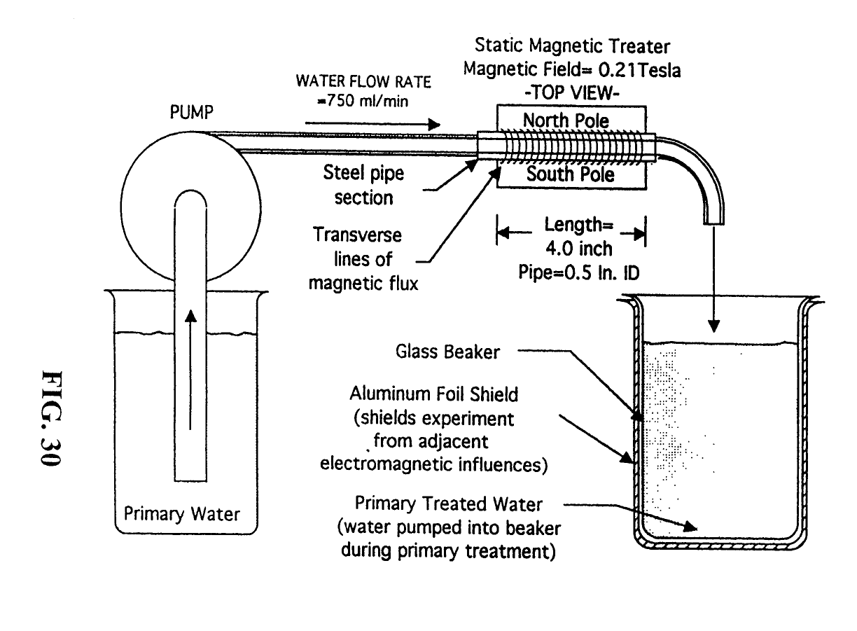

Water was treated magnetically for the purposes of these experiments by exposing it to the field of a permanent magnet using the apparatus shown schematically in FIG. 30. As illustrated in FIG. 30, tap water was passed through a pipe made of mild steel (⅝-inch i.d. and 1/16-inch wall thickness) positioned in the gap between the poles of a permanent magnet having a field strength of 0.21 Tesla. The pipe was believed to concentrate the magnetic field, with the magnetic lines of flux being transverse to the direction of water flow. The water was passed through the pipe at a rate of 500 ml/min (achieved with a peristaltic pump) within a length of ⅛-inch Tygon tubing and was placed in the shielded jars described above.

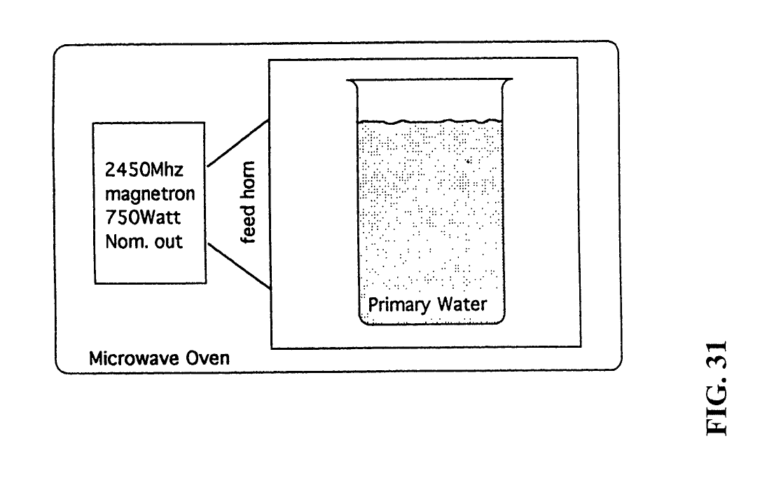

Water was treated with microwave energy for purposes of these experiments by exposing a two-liter polypropylene container of tap water to the output of a microwave oven having a 2450 MHz magneton operating at a nominal power of 750 watts for three minutes. The layout of the oven is illustrated schematically in the diagram attached as FIG. 31. After treatment, the excited water was allowed to cool to room temperature and placed in aluminum-shielded jars for use.

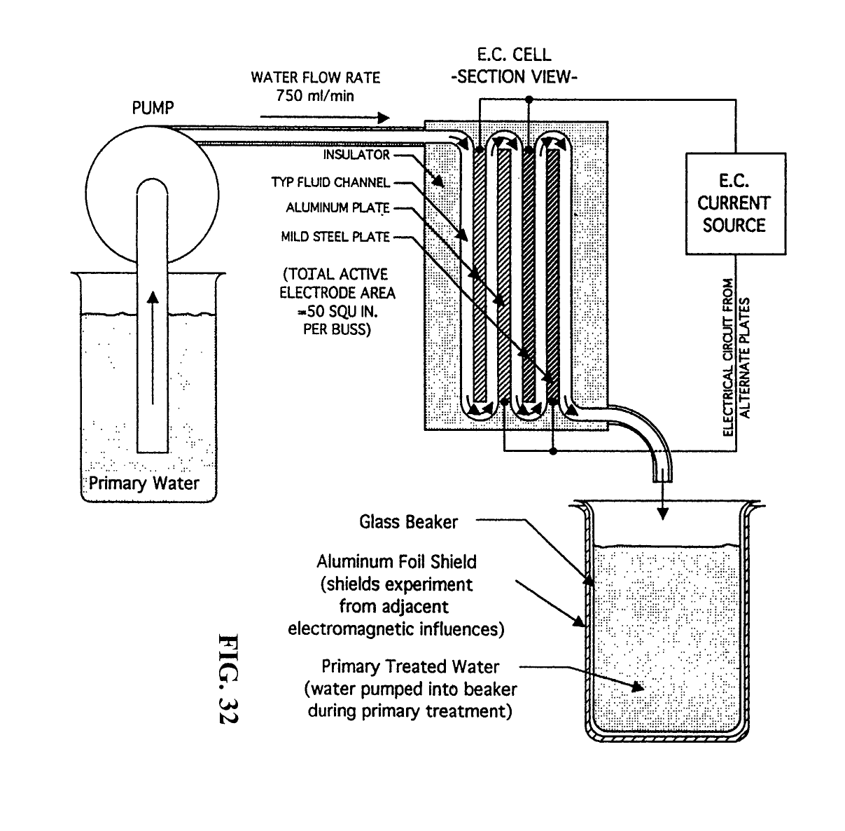

Water was exposed to an electric current for purposes of these experiments by passing a current directly through the water in a treatment cell of the type illustrated schematically in FIG. 32. As described above for magnetic treatment, tap water was passed through the apparatus at a rate of 500 ml/min with a peristaltic pump connected to ⅛th-inch i.d. Tygon tubing. The treatment cell was of the flow-through type, having planar passages arranged in “switchback” fashion between a series of parallel plates, the first two being aluminum and the second two being mild steel. A bias of 70 volts D.C. was applied between adjoining plates, causing a current of approximately 6 amperes to flow through the water. In the configuration used for these experiments, the current density through the water was 200 milliamperes per square inch and the water was exposed to the current for an average of 20 seconds. Polarity was reversed at two minute intervals during treatment.

The experiment took place over thirteen days during which time all 48 test tubes were exposed to sunlight on tables in a green house. The treated waters within the beakers were replaced every three days with freshly treated tap water, and the beakers rotated along the surface of the greenhouse tables to randomize with respect to the sunlight and any other environmental variables that might have existed in the greenhouse. The level of water in the test tubes was kept constant by adding untreated tap water, as needed to correct for evaporation. In addition, all of the water used in this experiment, whether inside the test tubes or in the mason jar beakers, was taken from a single body of water drawn from a tap at one time. This was done to eliminate differences in the water from one part of the experiment to the other.

At the end of the experiment, of the three type of plants, the barley and raddish seeds germinated quite well, while the wheat seeds had an extremely low germination rate, both in the beakers filled with treated waters and the “control” beaker filled with untreated tap water. It was determined that the wheat seeds were defective and thus there was not enough data on the wheat plants to analyze. However, the root systems of the test plants of the barley and radishes appeared on visual examination have more extensive root branching and possibly more elaborate root hair growth than the control plants. The shoot growth also appeared to be relatively longer for the test plants than the controls. Visual examination with the naked eye could not discern any differences between the test plants based the type of water treatment, i.e., magnetic, microwave or electric current.

The root hair length for the various rye samples were measured photovideo-graphically on an Olympus scope (model MJ) with dark and bright field capacity, polarizers and substage illumination. Images were recorded with a Panasonic color CCD video camera (CP410). Eight days after germination, roots were observed inside the test tubes under the water line. Identical sections of root were observed for comparison between test plants and control plants. For rye seedlings, the root hair of test plants grown in test tubes kept in all three forms of treated water were at least 50 percent longer than the root hair of the control plants. The average root length of rye plants grown in test tubes kept in water exposed to an electric discharge was 80 percent greater than the average root length of the corresponding control plants (27.00 cm vs. 15.05 cm). The same plants also demonstrated 33 percent more branching of lateral roots than the control plants (10.2 branches vs. 7.7 branches). Average lateral root branching was also increased for rye plants grown in test tubes kept in magnetically-treated water, as opposed to the roots of control plants (9.5 branches vs. 7.7 branches). These measurements therefore confirmed and quantified the visual differences noted above between the test plants and the control plants, all without contact of the treated waters to the root systems of the plants.

The data from this experiment demonstrates that the secondary treatment effects directly follow the primary treatment effects achieved using various sources of energy. Thus, when primary treated water is placed into proximity with untreated water, it stimulates the untreated water, believed to occur by the transfer of energy, perhaps photons, causing the untreated water to exhibit the same beneficial characteristics as the primary treated water. The transfer of energy to the untreated water solution does not require that the samples contact each other or are placed very close to each other, and the effects last much longer than the treatment period or any relaxation time predictable by currently known theories. However, from the foregoing, it is clear that once the secondary solution is treated, it can beneficially modify its performance in various processes. Possible examples of how the invention could be utilized is described below.

1. Changing Colloid Behavior in Cooling/Service Water Systems (Scale Control), e.g. Cooling Tower Descaling

The energy source, e.g., the delivery apparatus 322, stimulates the primary solution 314 using a magnetic, electromagnetic, or electric field, a visible or invisible broadband or monochromatic light or any other energy source. The primary solution 314 is thus placed into an altered energy state, and is transferred by a pump 332 or other means through closed loop pipe 324, tubing, etc. into the sump or holding tank 316 containing the coolant secondary solution 318. Energy emanating from the primary solution 314 is then radiated into the secondary solution 318, altering the physical characteristics of the secondary solution 318, i.e., pH, conductivity, zeta potential, surface tension, hydration force or any other characteristic of the secondary solution 318 to effect the attractiveness of colloidal particles in the secondary solution 318 to surfaces in the system. By applying the proper energy profile, scale particles will be repelled from surfaces contacting the secondary solution 318, inhibiting the formation of new scale, and promoting the removal of pre-existing scale buildup.

2. Printing Ink Treatment (Changing Font/Surface Adhesion Characteristics)

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing etc. into the sump or holding tank 316 containing the ink or font secondary solution 318. Energy emanating from the primary solution 314 is then radiated into the secondary solution 318, altering the physical characteristics of the secondary solution 318, i.e., pH, conductivity, zeta potential, surface tension, hydration force or any other characteristic of the secondary solution 318 to effect the attractiveness of colloidal particles in the primary solution 314 to the print medium. By applying the proper energy profile, ink or toner particles will be attracted to the printing media, resulting in improved print density, or more economical usage of ink or fonts.

3. De-inking of Pulp in Paper/Cardboard Recycling Processing/Removal of Ink or other Particles from Paper Slurry

The energy source, e.g., the delivery apparatus 322, stimulates the primary solution 314 using magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the process container tank 316 containing the process slurry 318. Energy emanating from the primary solution 314 is then radiated into the secondary solution 318, altering the physical characteristics of the secondary solution 318, i.e., pH, conductivity, zeta potential, viscosity, surface tension hydration force or any other characteristic of the secondary solution 318 to effect the attractiveness of colloidal particles in the secondary solution 318 to each other or to filter, skimmer, or other process elements. By applying the proper energy profile, ink, toner, or other particles will be either attracted to filter media, or be agglomerated as a froth at the surface to be skimmed off and disposed of.

4. Industrial Chemistry Process Enhancements/Chemical Process Synthesis Treatment

The energy source, e.g., the delivery apparatus 322, stimulates the primary solution 314 using a magnetic, electromagnetic, or electric field, visible or invisible broadband or monochromatic light or any other energy source. The primary solution 314 if thus placed into an altered energy state, and is transferred by a pump 332 or other means through closed loop pipe 324, tubing, etc. into the process container tank 316 containing the process solution 318. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to stimulate certain chemical reactions, or cause some enhancement of catalytic or other desired changes of chemistry.

5. Treating Water for Improvement of Strength of Concrete/Aggregate Mixes

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the process container/tank 316 containing the mix water 318. Energy emanating from the primary solution 314 is then radiated into the secondary solution 318 altering the physical characteristics of the secondary solution 318, i.e., pH, conductivity, zeta potential, viscosity, surface tension hydration force or any other characteristic of the secondary solution 318 to alter the curing time, the cured strength, the permeability, the porosity, or any other desirable effects of th finished concrete, including eliminating common salt types of additives which can attack and weaken reinforcing and metallic members in the pour.

6. Water Treatment to Enhance Plant Growth Cycles/Treatment of Water Agriculture/Plant Biology

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the process container/tank 316 containing the irrigation water 318. Energy emanating from the primary solution 314 is then radiated into the secondary solution 318, altering the physical characteristics of the secondary solution 318, i.e. pH, conductivity, zeta potential, viscosity, surface tension hydration force or any other characteristic of the secondary solution 318 to alter plant growth rates, plant size, fruit size and/or quality, plant susceptibility to disease or pests, plant water and nutrient requirements, and any other desirable effects on the plant species.

7. Medical/Biological Transfer and Treatment Techniques

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the treatment head/culture growth area/implant 316. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to alter cell growth rates, inhibit the growth of damaged or aberrant cells, stimulate the immune system function, stimulate the mending of broken bones, allow the removal of calcium deposits such as spurs, or allow removal of arterial plaque.

8. Wastewater/Effluent Treatment Using Energy Exchanger System

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred I a pump 332 or other means through closed loop pipe 324, tubing, etc. into the treatment pond/sump/stream 316. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to effect precipitation, flocculation or agglomeration of particles suspended in the wastewater effluent, allowing them to be sedimented, skimmed or filtered from the solution.

9. Liquid Hydrocarbon Fuel Treatment for Improved Combustion

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the fuel storage tank 316, an in-line fuel treatment cell or into the carburetion or induction systems. Energy emanating from the primary solution 314 is then radiated into the secondary solution 318, altering the physical characteristics the secondary solution 318, i.e., pH, conductivity, zeta potential, viscosity, surface tension, hydration force or any other characteristic of the secondary solution 318 which to modify complex hydrocarbon chains by cracking, molecular re-organization or attachment of OH radicals to improve the combustibility, modify the burn time or in any other way improve fuel economy or lower unwanted emissions of pollutants, including reduction of oxides of nitrogen, unburnt carbon or any other undesirable by-products of combustion.

10. Energy Treatment for an Icemaking Feedwater/Process

The energy source, e.g., the delivery apparatus 322, stimulates the primary solution 314 using a magnetic, electromagnetic, or electric field, visible or invisible broadband or monochromatic light or any other energy source. The primary solution 314 thus placed into an altered energy state, and is transferred by a pump 332 or other means through closed loop pipe 324, tubing, etc. into the icemaker feedwater holding tank 316, or ice maker water sump. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to effect the crystalline structure of ice to alter visual quality, melt time, entrainment of gasses, or other qualities of the ice.

11. Energetic Treatment of Steam/Water Vapor/Condensate Systems for Controlling Scale and Corrosion

The energy source, e.g., the delivery apparatus 322, stimulates the primary solution 314 using a magnetic, electromagnetic, or electric field, visible or invisible broadband or monochromat light or any other energy source. The primary solution 314 is thus placed into an altered energy state, and is transferred by a pump 332 or other means through closed loop pipe 324, tubing, etc. or water sump. Energy emanating from the primary solution 314 is then radiated into the secondary solution 318, altering the physical characteristics of the secondary solution 318, i.e. pH, conductivity, zeta potential, viscosity, surface tension hydration force or any other characteristic of the secondary solution 318 to effect the formation of scale or corrosion in boiler tubes/steam/condensate systems in boilers, industrial steam/low pressure vapor systems or other heat transfer surfaces.

12. System for Energetic Treatment of Injected Fuel Additives

The energy source, e.g., the delivery apparatus 322, stimulates the primary solution 314 using a magnetic, electromagnetic, or electric field, visible or invisible broadband or monochromatic light or any other energy source. The primary solution 314 thus placed into an altered energy state, and is transferred a pump 332 or other means through closed loop pipe 324, tubing, etc. into the injector solution additive holding tank 316. Energy emanating from the primary solution 314 is then radiated into the secondary solution 318, altering the physic characteristics of the secondary solution 318, i.e., pH, conductivity, zeta potential, viscosity, surface tension, hydration force or any other characteristic of the secondary solution 318 to effect the characteristics of that solution when injected into the fuel source, induction system or combustion chamber, to improve fuel characteristics, reduce unwanted exhaust emissions, modify fuel burn characteristics, reduce pinging and knock or otherwise improve engine performance.

13. Treatment of Water in De-Salination Systems

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the de-salination system inlet water 318. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to effect the characteristics of salt water such that colloidal particles will flocculate or agglomerate allowing pre-filtration of the water by such means as large mesh mechanical filtration or centrifugation.

14. Treatment of Chemistry in Semiconductor Disposition Systems

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the deposition system holding tank 316. Energy emanating from the primary solution 314 is then radiated into the secondary solution 318, altering the physical characteristics of the secondary solution 318, i.e., pH, conductivity, zeta potential, viscosity, surface tension, hydration force or an other characteristic of the secondary solution 318 to effect the characteristics of surface attraction to deposition solution colloidal particles, such that thinner and more uniform coatings can be applied.

15. Enhancement in Photographic Emulsions/Photodevelopment Cycles, e.g., in Semiconductor Deposition Systems

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the deposition system holding tank 316. Energy emanating from the primary solution 314 is then radiated into the secondary solution 318, altering the physical characteristics the secondary solution 318, i.e., pH, conductivity, zeta potential, viscosity, surface tension, hydration force or any other characteristic of the secondary solution 318 to effect the characteristics of the quality and size distribution of colloid particles in photographic emulsions to improve grain size and color rendition and to treat various solutions used in development and processing to improve the rate of absorption/uniformity of development to enhance image quality and throughput times.

16. Improvement of Paint Application Adhesion and Curing

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through a closed loop pipe 324, tubing, etc. into the system holding tank 316. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to effect the characteristics of the quality and size distribution of colloidal particles in paint emulsions during manufacture and application of paints to control pigment size distribution, bas polymer characteristics as well as sag, coating thickness, drying time, finish quality, and hardness.

17. Enhancement of Electroplating Processes

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the plating solution/plating tank 316. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the secondary solution 318 to effect the characteristics of the plating solution to control the purity, density or porosity of electroplated surfaces.

18. Treatment of Water to Reduce Evaporative Loss in Agricultural Irrigation

The energy source, e.g., the delivery apparatus 322, stimulates the primary solution 314 using a magnetic, electromagnetic, or electric field, visible or invisible broadband or monochromatic light or any other energy source. The primary solution 314 is thus placed into an altered energy state, and is transferred by a pump 332 or other means through closed loop pipe 324, tubing, etc. into the process container/tank 316 containing the irrigation water 318. Energy emanating from the primary solution 314 is then radiated into the secondary solution 318, altering the physical characteristics of the secondary solution 318, i.e., pH, conductivity, zeta potential, viscosity, surface tension, hydration force or any other characteristic of the second solution 318 to effect the rate at which water is absorbed by soil growth medium and reduce water usage and thus increase profitability of agribusiness.

Although the present invention has been described in detail with reference only to the presently-preferred embodiments, those of ordinary skill in the art will appreciate that various modifications can be made without departing from the invention. For example, one of ordinary skill in the art can envision other systems that cause the primary 314 and secondary 318 solutions to be transported proximate to each other to remotely treat the secondary solution. Additionally, one can envision any of the disclosed embodiments combined with any of the disclosed radiators, or equivalents, to improve the efficacy of the delivery apparatus. Accordingly, the invention is defined by the following claims.

What is claimed is:

1. A process for affecting physical characteristics of a target solution by transferring energy from a first aqueous solution, comprising the steps of:
delivering electromagnetic energy into the first aqueous solution such that a portion of the energy is absorbed into the first aqueous solution for release from the first aqueous solution over time; and
transferring electromagnetic energy from the first aqueous solution to the target solution by positioning the first aqueous solution relative to the target solution in order to alter a non-thermal physical characteristic of the target solution taken from the group of zeta potential, pH, surface tension, turbidity, conductivity, hydration force, and viscosity.

2. The process of claim 1, including the step of monitoring the altered non-thermal physical characteristic of the target solution, and determining when the non-thermal physical characteristic of the target solution has reached a predetermined parameter.

3. The process of claim 2, wherein the monitoring step includes the step of altering the transfer of energy from the primary aqueous solution into the target solution in order to reach the predetermined parameter.

4. The process of claim 3, including the step of altering the delivery of electromagnetic energy into the primary aqueous solution.

5. The process of claim 4, including the step of increasing the electromagnetic energy delivered to the primary aqueous solution over time.

6. The process of claim 4, including the step of decreasing the electromagnetic energy delivered to the primary aqueous solution over time.

7. The process of claim 4, including the step of increasing the exposure of the target solution to the primary aqueous solution.

8. The process of claim 4, including the step of decreasing the exposure of the target solution to the primary aqueous solution.

9. The process of claim 1, wherein the electromagnetic energy delivered to the primary aqueous solution comprises electric current.

10. The process of claim 1, wherein the electromagnetic energy delivered to the primary aqueous solution comprises magnetic energy.

11. The process of claim 1, wherein the electromagnetic energy delivered to the primary aqueous solution comprises light energy.

12. The process of claim 1, wherein the electromagnetic energy delivered to the primary aqueous solution comprises radio frequency energy.

13. The process of claim 1, wherein the monitoring step includes monitoring the energy content of the primary aqueous solution.

14. The process of claim 1, including the step of placing the first aqueous solution into a non-metallic container.

15. The process of claim 14, including the step of placing the target solution in a non-metallic container.

16. A process for affecting physical characteristics of a target solution by transferring energy from a first aqueous solution, comprising the steps of:
delivering electromagnetic energy taken from the group of electric current, magnetic energy, light energy, and radio frequency energy into the first aqueous solution such that a portion of the energy is absorbed into the first aqueous solution for release from the first aqueous solution over time;
transferring electromagnetic energy from the first aqueous solution to the target solution by positioning the first aqueous solution relative to the target solution in order to alter a non-thermal physical characteristic of the target solution;
monitoring the altered non-thermal physical characteristic of the target solution; and
determining when the non-thermal physical characteristic of the target solution has reached a predetermined parameter.

17. The process of claim 16, wherein the monitoring step includes the step of altering the transfer of energy from the primary aqueous solution into the target solution in order to reach the predetermined parameter.

18. The process of claim 17, including the step of altering the delivery of electromagnetic energy into the primary aqueous solution.

19. The process of claim 17, including the step of increasing the electromagnetic energy delivered to the primary aqueous solution over time.

20. The process of claim 17, including the step of decreasing the electromagnetic energy delivered to the primary aqueous solution over time.

21. The process of claim 17, including the step of increasing the exposure of the target solution to the primary aqueous solution.

22. The process of claim 17, including the step of decreasing the exposure of the target solution to the primary aqueous solution.

23. The process of claim 16, wherein the transferring step includes the step of altering the pH of the target solution.

24. The process of claim 16, wherein the transferring step includes the step of altering the surface tension of the target solution.

25. The process of claim 16, wherein the transferring step includes the step of altering the turbidity of the target solution.

26. The process of claim 16, wherein the transferring step includes the step of altering the conductivity of the target solution.

27. The process of claim 16, wherein the transferring step includes the step of altering the hydration force of the target solution.

28. The process of claim 16, wherein the transferring step includes the step of altering the viscosity of the target solution.

29. The method of claim 16, wherein the transferring step includes the step of altering the zeta potential of the target solution.

30. The process of claim 16, wherein the determining step includes monitoring the energy content of the primary aqueous solution.

31. The process of claim 17, including the step of placing the first aqueous solution into a non-metallic container.

32. The process of claim 31, including the step of placing the target solution in a non-metallic container.

33. A process for affecting physical characteristics of a target solution by transferring energy from a first aqueous solution, comprising the steps of:
delivering electromagnetic energy taken from the group of electric current, magnetic energy, light energy, and radio frequency energy into the first aqueous solution such that a portion of the energy is absorbed into the first aqueous solution for release from the first aqueous solution over time;
transferring electromagnetic energy from the first aqueous solution to the target solution by positioning the first aqueous solution relative to the target solution in order to alter a non-thermal physical characteristic of the target solution taken from the group of zeta potential, pH, surface tension, turbidity, conductivity, hydration force, and viscosity;
monitoring the altered non-thermal physical characteristic of the target solution; and
determining when the non-thermal physical characteristic of the target solution has reached a predetermined parameter.

34. The process of claim 33, wherein the monitoring step includes the step of altering the transfer of energy from the primary aqueous solution into the target solution in order to reach the predetermined parameter.

35. The process of claim 34, including the step of altering the delivery of electromagnetic energy into the primary aqueous solution.

36. The process of claim 34, including the step of increasing the electromagnetic energy delivered to the primary aqueous solution over time.

37. The process of claim 34, including the step of decreasing the electromagnetic energy delivered to the primary aqueous solution over time.

38. The process of claim 34, including the step of increasing the exposure of the target solution to the primary aqueous solution.

39. The process of claim 34, including the step of decreasing the exposure of the target solution to the primary aqueous solution.

40. The process of claim 33, wherein the monitoring step includes monitoring the energy content of the primary aqueous solution.

41. The process of claim 33, including the step of placing the first aqueous solution into a non-metallic container.

42. The process of claim 41, including the step of placing the target solution in a non-metallic container.
